(19) United States
(12) Patent Application Publication
(10) Pub. No.: US 2011/0317935 A1
(43) Pub. Date: Dec. 29, 2011

(54) IMAGE PROCESSING DEVICE, METHOD THEREOF, AND A COMPUTER READABLE NON TRANSITORY STORAGE MEDIUM STORING AN IMAGE PROCESSING PROGRAM

(75) Inventors: Taizo ANAN, Kawasaki (JP); Jun Takahashi, Kawasaki (JP); Kensuke Kuraki, Kawasaki (JP); Shohei Nakagata, Kawasaki (JP)

(73) Assignee: FUJITSU LIMITED, Kawasaki-shi (JP)

(21) Appl. No.: 13/104,599

(22) Filed: May 10, 2011

(30) Foreign Application Priority Data
Jun. 25, 2010 (JP) 2010-144862

(51) Int. Cl. G06K 9/40

(52) U.S. Cl. 382/274

(57) ABSTRACT

An image processing device includes, a block division unit configured to divide at least a part of an area of an input image into a plurality of blocks; a block classification unit configured to classify each block in the input image into a white block and a black block based on a variance of luminance values in a white block that typically includes white pixels and a variance of luminance values in a black block that includes at least black pixels among white pixels and black pixels; and a luminance correction unit configured to correct a luminance value of each pixel in a black block in the input image based on an average luminance value of pixels in one or more white blocks in the vicinity of the black block.

### CROSS-REFERENCE TO RELATED APPLICATION

This application is based upon and claims the benefit of priority of the prior Japanese Patent Application No. 2010-144862, filed on Jun. 25, 2010, the entire contents of which are incorporated herein by reference.

### FIELD

The embodiments discussed herein relate to an image processing device, method thereof, and a computer readable storage medium storing an image processing program.

### BACKGROUND

Recently, preventing a leakage of confidential information printed on a printed material such as paper has been desired. A technology that visually encrypts confidential information and prints the information to prevent a leakage of printed information is considered. Japanese Laid-open Patent Publication No. 2008-301044 discusses an encryption device that encrypts a part of an input image and attaches markers, for example, at four corners of the encrypted area. The image is encrypted, for example, by rearranging positions of pixels in the encryption target area of the input image in a unit of block each of which is made up of a plurality of pixels.

The image encrypted by the encryption device is printed, for example, on a paper medium. The printed image is read by a reader such as a camera, converted into a digital image, and is supplied to a decryption device. The decryption device identifies the encrypted area based on the positions of the markers in the input digital image. The decryption device restores the original image by decrypting the image in the identified area.

Japanese Laid-open Patent Publication No. 2007-300320 discusses a white balance adjustment as a technology to correct quality of an image picked up by a camera. A technology for a camera with a white balance adjustment function is discussed that divides a pick-up image into blocks with a certain size and divides the same image into blocks with a size smaller than the certain size as well. The camera then calculates two types of white balance correction values by using the blocks with the two different sizes and applies a weighted addition to each white balance adjustment value according to a sensitivity. Japanese Laid-open Patent Publication No. 2001-169307 discusses a technology that divides a pick-up image into a plurality of blocks and reduces a convergence determination width between color signals to determine whether white balance adjustment is converged when the number of blocks determined to be a white area is increased.

### SUMMARY

In accordance with an aspect of the embodiments, an image processing device includes, a block division unit configured to divide at least a part of an area of an input image into a plurality of blocks; a block classification unit configured to classify each block in the input image into a white block and a black block based on a variance of luminance values in a white block that typically includes white pixels and a variance of luminance values in a black block that includes at least black pixels among white pixels and black pixels; and a luminance correction unit configured to correct a luminance value of each pixel in a black block in the input image based on an average luminance value of pixels in one or more white blocks in the vicinity of the black block. The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a configuration example of an image processing device according to a first embodiment.

FIG. 2 is a configuration example of a system that prints and reads an encrypted image.

FIG. 3 illustrates procedures to generate an encrypted image in the image processing device.

FIG. 4 illustrates procedures to decrypt an encrypted image in a mobile phone.

FIG. 5 illustrates degradation of image quality in a decrypted image.

FIG. 6 is a hardware configuration example of a mobile phone.

FIG. 7 is a block diagram illustrating functions provided with a mobile phone.

FIG. 8 illustrates a labeling process.

FIG. 9 illustrates statistical characteristics of encrypted images.

FIG. 10 is an example of blocks in a picked-up encrypted image.

FIG. 11 is a flow chart illustrating an entire processing procedure to display an encrypted image executed by a mobile phone.

FIG. 12 is a flow chart illustrating a first example of block classification processing.

FIG. 13 is a flow chart illustrating a second example of block classification processing.

FIG. 14 is a flow chart illustrating a processing procedure to correct image quality.

FIG. 15 is a flow chart illustrating a first processing example of a labeling.

FIG. 16 is a flow chart of a second processing example of a labeling.

FIG. 17 is a hardware configuration example of a computer according to a third embodiment.

### DESCRIPTION OF EMBODIMENTS

Verification by the inventor revealed a disadvantage that non-uniform luminance is caused on a digital image that is read depending on environmental conditions such as an angle between a reader and a printed material and how light is illuminated when an image printed on the printed material is read by the reader. Particularly, when a printed material is picked up by a camera as a reader, stable environmental conditions are difficult to achieve because the camera and the printed material are spaced apart. Accordingly, it is newly found that an image picked up by a camera tends to cause non-uniform luminance.

Moreover, when a black and white image, especially a binary image is encrypted and printed, there is a disadvantage in which quality of the decrypted image is degraded if the above-described non-uniform luminance is caused when reading the encrypted image from the printed material. In a digital image obtained by reading an encrypted image, an area where luminance is high and an area where luminance is low are concentrated in different areas to some extent depending on the environmental conditions. However, blocks in the encrypted area are rearranged at decryption. Therefore, verification by the inventor additionally revealed that pixels the luminance of which are high and pixels the luminance of which are low are diffused in the encrypted area respectively depending on the environmental conditions if there is any non-uniform luminance in the encrypted area.

Thus, in the decrypted image, for example, pixels with extremely different luminance are dispersed, in other words, a noise is caused in a white area the luminance of which is originally uniform. The verification by the inventor additionally revealed that the noise caused due to non-uniform luminance tends to be more conspicuous over a black and white image; thereby the noise is a major factor to degradation of the decrypted image quality.

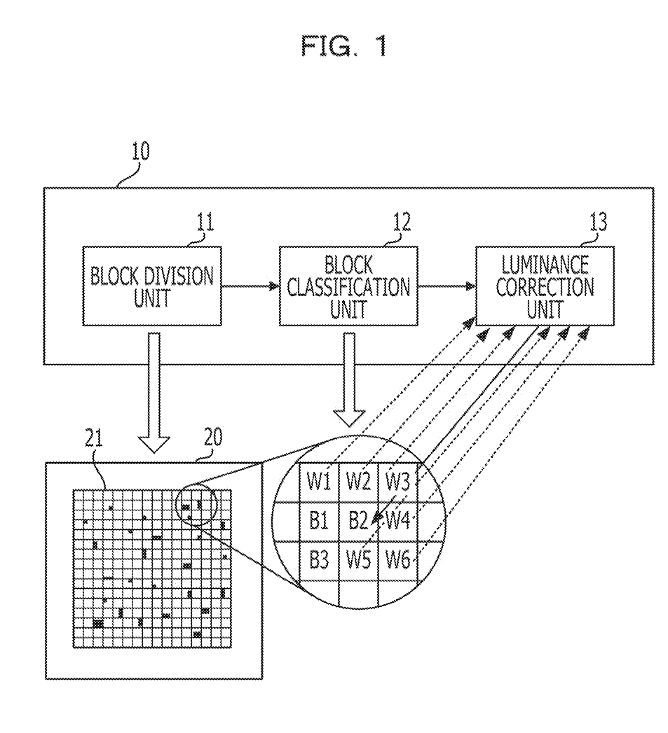

FIG. 1 is a configuration example of an image processing device according to the first embodiment.

An input image (input image 20) that is input to an image processing device 10 illustrated in FIG. 1 is read from a printed material by a reader, for example, a camera or a scanner. Non-uniform luminance may be caused in the input image 20 depending on environmental conditions when the image is read. Particularly, when an image is picked up by a camera, light is not likely to illuminate uniformly over the printed material and non-uniform luminance tends to be caused because a camera and a printed material are spaced apart. The image processing device 10 suppresses the non-uniform luminance in the input image 20 caused due to the above-described environmental conditions and executes processing to improve the image quality.

The image processing device 10 includes a block division unit 11, a block classification unit 12, and a luminance correction unit 13. The block division unit 11 divides at least a part of an area in the input image 20 into a plurality of blocks. The block, here, is made up of a plurality of adjacent pixels. The area divided into blocks is, for example, an area in which an encrypted image 21 is disposed in the input image 20. The encrypted image 21 is an image obtained by visually encrypting an original image using an encryption key. Particularly, the encrypted image 21 may be obtained by dividing the original image into blocks and rearranging the blocks based on a decryption key. Note that a block that is a unit for rearrangement and a block obtained by division performed by the block division unit 11 may not be necessarily the same.

The block classification unit 12 classifies each of the blocks obtained by division performed by the block division unit 11 into white blocks that typically include white pixels, and black blocks that are other than the white blocks. In FIG. 1, the blocks W1 to W6 are blocks classified into white blocks (hereinafter, simply called white blocks) while blocks B1 to B3 are blocks classified into black blocks (hereinafter, simply called black blocks).

The block classification unit 12 classifies each of the divided blocks into white blocks and black blocks based on statistical characteristics of luminance values in a white block and luminance values in a black block. For example, the block classification unit 12 classifies each block based on a variance of luminance values in a white block and a variance of luminance values in a black block.

When a blur is caused or resolution of an image pickup element is low in the input image 20 that is read by the reader, bleeding of a black pixel is likely to be caused. On the other hand, white pixels remain to be white even when a blur is caused. Accordingly, a variance of luminance values tends to be greater for a block that includes a black pixel, compared with the block that does not include any black pixel. Moreover, a block that includes both black and white pixels, it is obvious that the variance of luminance values is greater compared with a block that does not include any black pixel.

The block classification unit 12 may classify blocks into either white blocks and black blocks with high accuracy by utilizing a difference between a variance of luminance values in a black block and a variance of luminance values in a white block. The block classification unit 12 calculates a variance of luminance values for pixels in a block of the input image 20 and compares the calculated variance with a certain threshold. When the calculated variance is threshold or more, the block classification unit 12 classifies the block as a black block. When the calculated variance is threshold or less, the block classification unit 12 classifies the block as a white block.

Alternatively, the block classification unit 12 may calculate at least one of a probability that a block in the input image 20 is a white block or a probability that a block in the input image 20 is a black block and may classify a block based on the calculated probabilities. The block classification unit 12 uses a first variance in a block that is defined as a variance of luminance values in a white block and a second variance in a block that is defined as a variance of luminance values in a black block, where the second variance in the block is greater than the first variance in the block. As a result, the above described difference of statistical characteristics is reflected to the calculation of the probability, thereby highly accurate block classification may be achieved.

The luminance correction unit 13 corrects a luminance value of each pixel in an area to which block division is applied among areas of the input image 20 so as to suppress non-uniform luminance. A white block typically includes white pixels, thus an average luminance value of pixels in a white block may be considered to accurately reflect a degree that brightness is reduced when the reader reads the image compared with an average luminance value of pixels in a black block. Thus, the luminance correction unit 13 corrects a luminance value of each pixel in a black block to be corrected based on an average luminance value of pixels in one ore more white blocks in the vicinity of the black block. Accordingly, the luminance value of each pixel in the black block may be corrected accurately so as to suppress non-uniform luminance.

When a luminance value of each pixel in the black block is corrected, it is desirable to select a white block that is close to the black block as much as possible and obtain an average luminance value of pixels in the selected white block. In the example illustrated in FIG. 1, white blocks W1 to W6 are adjacent to the black block B2. Accordingly, the luminance correction unit 13 corrects the luminance value of each pixel in the black block B2 based on the average luminance value of pixels in the white blocks W1 to W6.

The luminance correction unit 13 calculates, for example, at least one of a probability that each pixel in a black block to be corrected is a white pixel or a probability that each pixel in the black block is a black pixel. The luminance correction unit 13 corrects a luminance value of each pixel in the black block based on the calculated probability. The luminance correction unit 13 uses, when calculating the probabilities, a first variance that is defined as a variance of luminance values of white pixels and a second variance that is defined as a variance of luminance values of black pixels, where the second variance is greater than the first variance. Moreover, the luminance correction unit 13 sets, when calculating the probabilities, an average luminance value of pixels in one or more white blocks in the vicinity of the black block to be corrected as an average luminance value of white pixels in the black block. As a result, the difference of statistical characteristics of white pixels and black pixels, and a degree of brightness reduction based on luminance values in the white blocks in the vicinity of the black block are reflected to the probability calculation. Accordingly, a luminance value of each pixel in the black block may be corrected with high accuracy so as to suppress non-uniform luminance.

The encrypted image 21 the luminance values of which are corrected by the luminance correction unit 13 is decrypted, for example, by rearranging the blocks using a decryption key. In this case, a noise caused in the decrypted image due to non-uniform luminance is suppressed and the image quality after decryption is improved.

As an example of a device with functions of the above-described image processing device 10, an image pick-up device is described. In a second embodiment below, a mobile phone with an image pickup unit is described as an example of an image pick-up device.

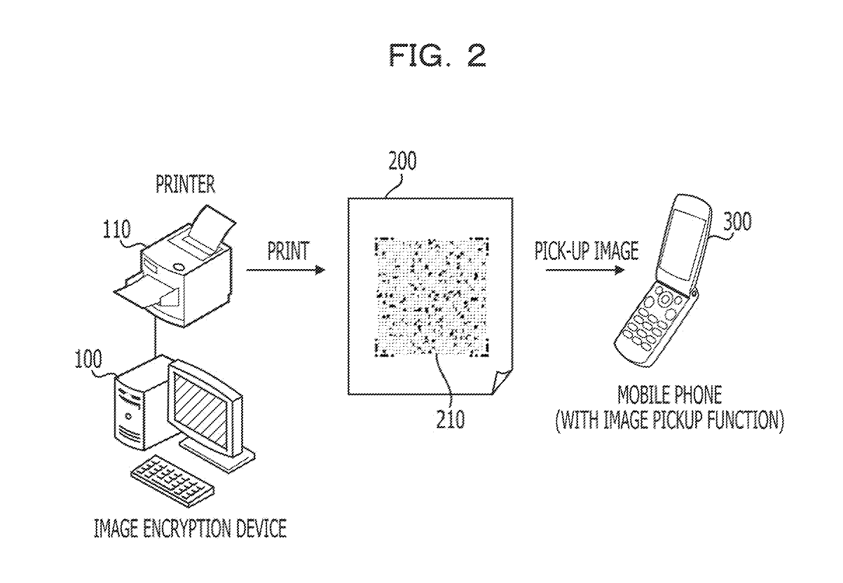

FIG. 2 is a configuration example of a system that prints and reads an encrypted image.

An image encryption device 100 illustrated in FIG. 2 generates image data to be printed on a printed material 200. The printed material 200 may be a paper medium, for example. A printer 110 is connected to the image encryption device 100. The printer 110 prints an image on the printed material 200 based on the image data received from the image encryption device 100.

The image encryption device 100 may encrypt at least a part of an area in an image to be printed on the printed material 200. Hereinafter, an encrypted image in the image printed on the printed material 200 is called an encrypted image 210.

The encrypted image 210 is read by a reader and converted into a digital image. According to the embodiment, as an example of the reader, a mobile phone 300 with an image pickup function is used. The reader may not be limited to mobile phones but may be various image pick-up devices or scanners.

The mobile phone 300 generates a digital image by picking up the encrypted image 210 and decrypts an area of the encrypted image 210 in the digital image to restore the original image. The restored original image is displayed, for example, on a monitor of the mobile phone 300.

Hereinafter, procedures to generate the encrypted image 210 and then procedures to decrypt the image will be described. After that, a disadvantage of quality degradation of the decrypted image will be described. Moreover, processing executed by the mobile phone 300 to suppress quality degradation of a decrypted image will be described.

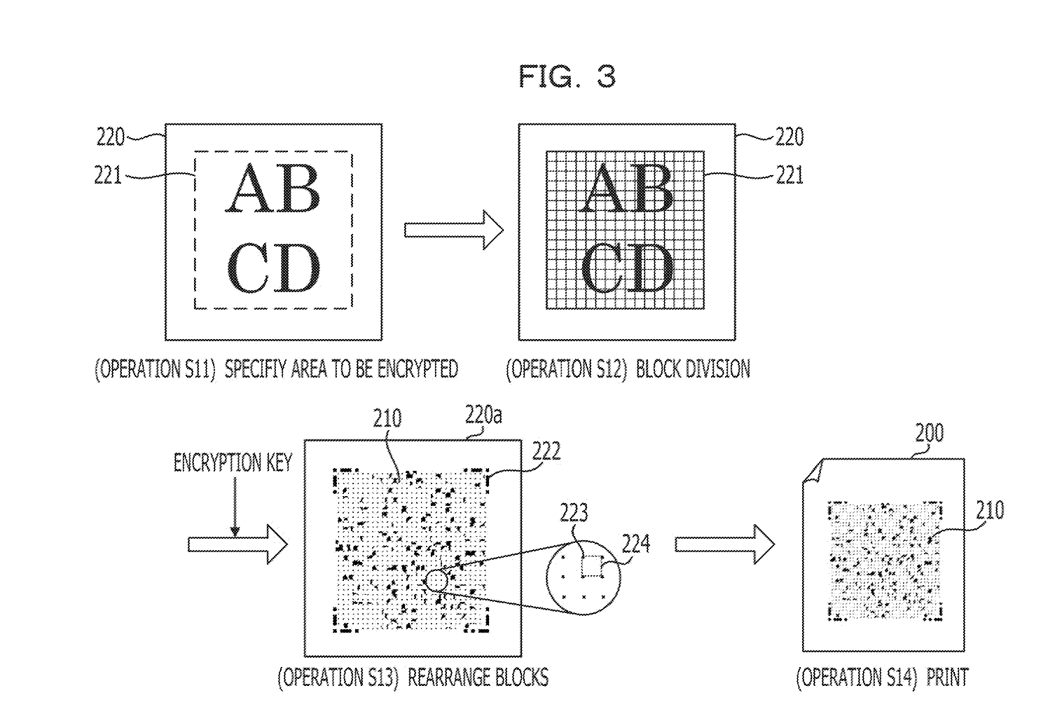

FIG. 3 illustrates procedures to generate an encrypted image in the image processing device.

The image encryption device 100 specifies an area to be encrypted (encryption target area 221) in the input image 220 (Operation S11). The input image 220 is a black and white image in which each pixel typically has luminance data. However, a value that each pixel of the input image 220 has may be desirably two values, one is close to the minimum value, and the other is close to substantially the maximum value. This is because; higher the contrast for the background, images that are included in the encryption target area 221 such as characters, figures, and pictures may be easily identified by a human when the image is decrypted. The encryption target area 221 may be set by an input operation by an operator who operates the image encryption device 100.

The image encryption device 100 divides the encryption target area 221 into a plurality of blocks each of which is made up of substantially the same number of pixels (Operation S12). The block is, for example, a rectangular area of 8×8 pixels.

The image encryption device 100 converts an image in the encryption target area 221 into an encrypted image 210 by rearranging blocks in the encrypted target area 221 according to a rule defined by an encryption key (Operation S13). For example, when the encryption target area 221 includes a character, a human may not read the character in the encryption target area 221 after rearranging the blocks. Various methods may be considered to rearrange blocks using an encryption key. For example, a method may be applied in which a block in a position determined based on an encryption key is replaced with a block in another position determined by the encryption key.

The image encryption device 100 may add information that functions as a marker to identify the encryption target area 221 or a position of a block when decrypting the image. According to the embodiment, as an example, the image encryption device 100 adds area identification markers 222 at four corners of the encryption target area 221. The area identification marker 222 is information used to identify the encryption target area 221 when decrypting the image. A position to which the area identification marker 222 is attached and the shape of the area identification marker 222 are not limited as long as a decryption device may recognize the encryption target area 221.

The image encryption device 100 attaches a block identification marker 223 to a certain position of each block after rearranging the blocks. The block identification marker 223 is information used to identify a position of each block when decrypting the image. In the example illustrated in FIG. 3, the block identification marker 223 is attached by converting a plurality of pixels at an upper left of each block 224 into the pixels with luminance value 0. The block identification marker 223 may not necessarily be attached to all blocks. For example, the block identification marker 223 may be added at least to a block that does not include any black pixel. A position to which the block identification marker 223 is attached or the shape of the block identification marker 223 are not limited as long as the decryption device may recognize the block identification marker 223.

The image encryption device 100 transmits data of an image 220a that is obtained by encrypting the encryption target area 221 in the input image 220 to the printer 110 and makes the printer 110 print the image 220a on the printed material 200 (Operation S14). As a result, the encrypted image 210 is printed on the printed material 200.

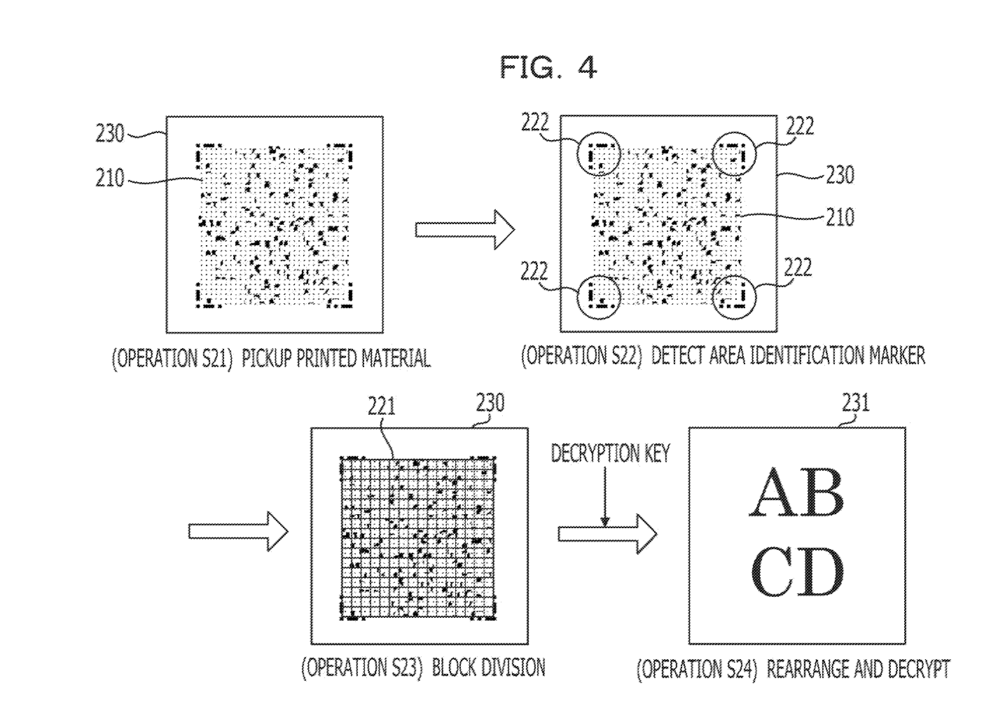

FIG. 4 illustrates procedures to decrypt an encrypted image in a mobile phone. The image pickup unit of the mobile phone 300 picks up an image printed on the printed material 200 and obtains a pick-up image 230 (Operation S21). The pick-up image 230 includes the encrypted image 210.

The mobile phone 300 applies image processing to the pick-up image 230 and detects the area identification markers 222 attached four corners of the encrypted image 210 (Operation S22). The mobile phone 300 identifies an area of the encrypted image 210 (the above-described encryption target area 221) based on positions of the area identification markers 222. The mobile phone 300 may correct distortion of the identified encryption target area 221.

Moreover, the mobile phone 300 detects the block identification markers 223 in the identified encryption target area 221 and divides the encryption target area 221 into blocks based on the positions of the block identification markers 223 (Operation S23). The block identification markers 223 may be used to correct distortion of the encryption target area 221.

The mobile phone 300 decrypts the image of the encryption target area 221 by rearranging blocks according to a rule defined by a decryption key to restore the original image (Operation S24). The mobile phone 300 makes own monitor display a decrypted image 231 obtained by decrypting the encryption target area 221 in the pick-up image 230. The mobile phone 300 may store data of the decrypted image 231 in a storage medium or may transmit the data to another device.

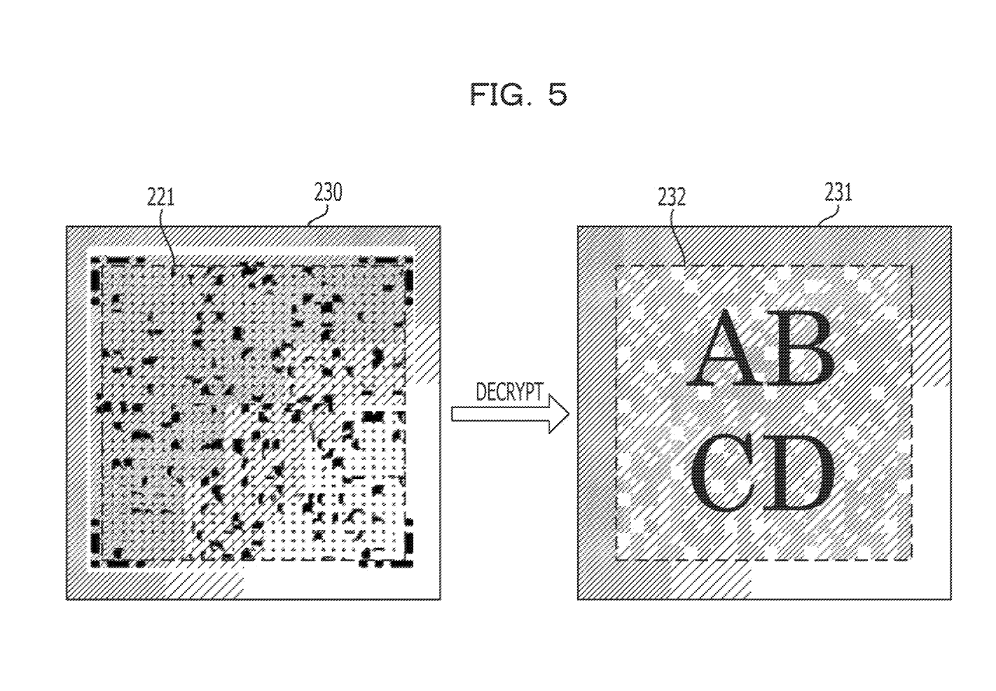

Hereinafter, a problem caused in a decrypted image will be described. FIG. 5 illustrates degradation of image quality in a decrypted image. In the description below, as an example, a black character with substantially the lowest luminance is assumed to be drawn over a white background with substantially the highest luminance in an original image in an encryption target area. When the above described original image is encrypted and printed on a printed material, the printed encrypted image is still made up of white or black pixels as long as a surface of the printed material is white.

However, when an image printed on a printed material is picked up by an image pick-up device, non-uniform luminance may be caused over a pick-up image 230 obtained by the image pick-up depending on environmental conditions such as an angle between the pick-up device and the printed material, and how light is illuminated. Particularly, when a printed material is picked-up by a camera as a reader, stable environmental conditions are difficult to achieve and non-uniform luminance is likely to cause because the camera and the printed material are usually spaced apart.

When non-uniform luminance is caused due to environmental conditions, usually a relatively light area is concentrated on an area of the pick-up image, while a relatively dark area is concentrated in another area. In the example of the pick-up image 230 in the left side of FIG. 5, an area at the lower right of the pick-up image 230 is bright while that of the upper left is dark. Among pixels included in the encryption target area 221 of the pick-up image 230, luminance values of pixels that are in a background in the original image before the encryption (hereinafter referred to as a background pixel) should be substantially the maximum value. However, when non-uniform luminance is caused, luminance values of a part of the background pixels decrease. Especially, luminance values of background pixels arranged in substantially the brightest area (lower right of the left figure in FIG. 5) in the encryption target area 221 are substantially the maximum values, while luminance values of the background pixels arranged in substantially the darkest area (upper left of the left figure in FIG. 5) are considerably reduced from substantially the maximum value.

When the encryption target area 221 of the pick-up image 230 is decrypted from the above described state, blocks in the encryption target area 221 are rearranged according to a decryption key. At this time, as in the decrypted image 231 illustrated in the right side of FIG. 5, background pixels the luminance values of which differ diffuse in the entire encryption target area 221. Therefore, pixels with different luminance values are dispersed in the decrypted image 231 obtained by decrypting the encryption target area 221 in the background except for the character area, and thereby quality of the decrypted image 231 is degraded. Particularly, when extremely bright pixels are distributed in an area with reduced luminance values in the background area, the extremely bright pixels are conspicuous, and a viewer who views the decrypted image 231 is more likely to feel degradation of the image quality.

Thus, the mobile phone 300 according to the embodiment applies image quality correction processing before rearranging blocks in the encryption target area 221. The image quality correction processing suppresses non-uniform luminance in the pick-up image and makes a noise inconspicuous in the decrypted image. When correcting image quality, a white block that does not include any black pixel is extracted from the image in the encryption target area 221 based on a variance of luminance values in each block and luminance values of black blocks that are other than the white blocks are corrected based on luminance values of white blocks around the black blocks.

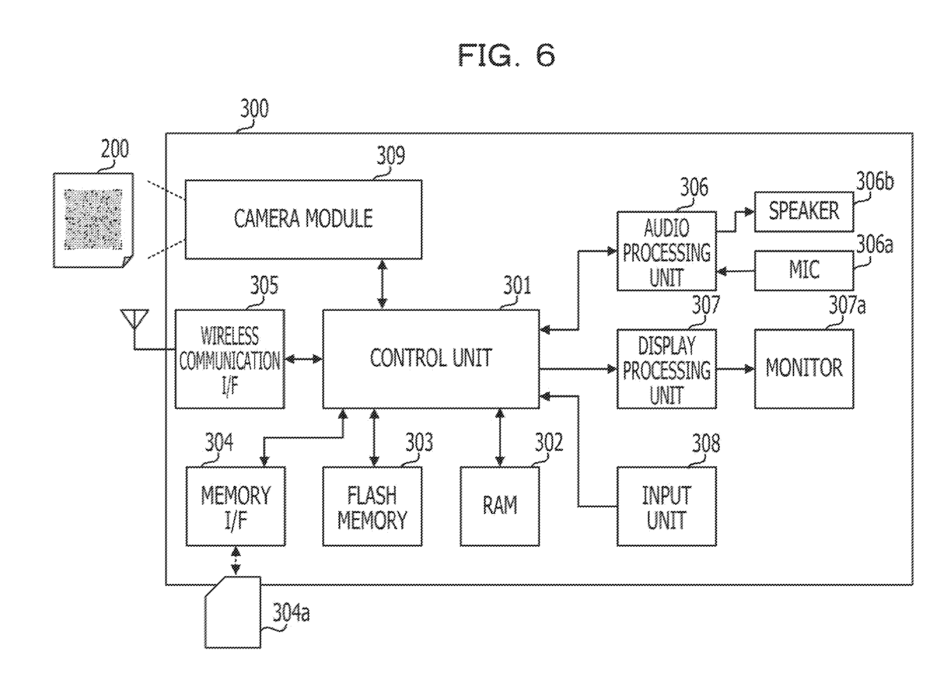

FIG. 6 is a hardware configuration example of a mobile phone. The mobile phone 300 includes a control unit 301, a Random Access Memory (RAM) 302, a flash memory 303, a memory interface (I/F) 304, a wireless communication interface (I/F) 305, an audio processing unit 306, a microphone 306a, a speaker 306b, a display processing unit 307, a monitor 307a, an input unit 308, and a camera module 309.

The control unit 301 centrally controls each block in the mobile phone 300. The control unit 301 includes, for example, a Central Processing Unit (CPU), and executes various processing by making the CPU execute a program stored, for example, in a flash memory 303. The control unit 301 executes, for example, call processing through a wireless communication interface 305, decryption processing of an encrypted image using an image that is picked-up by the camera module 309, and image quality correction processing for an image to be decrypted. The above-described processing functions may be implemented as a plurality of hardware components in the control unit 301.

The RAM 302 temporarily stores at least a part of programs executed by the control unit 301. The RAM 302 stores various pieces of data required for processing by the control unit 301.

The flash memory 303 stores programs executed by the control unit 301 and data required for processing by the control unit 301. Other types of non-volatile storage mediums may be used as a storage medium that achieves substantially the same functions as the functions of the flash memory 303.

A portable memory 304a is removably connected to a memory interface 304. The portable memory 304a is, for example, a flash memory. The memory interface 304 transmits and receives data between the portable memory 304a and the control unit 301.

A wireless communication interface 305 is an interface circuit that wirelessly connects to a wireless network, which is not illustrated. The wireless communication interface 305 is provided, for example, with a Radio Frequency (RF) circuit and a modulation/demodulation circuit for transmission and reception signals.

The audio processing unit 306 converts an audio signal from the microphone 306a into a digital signal, and encodes to a certain format to output to the control unit 301. Moreover, the audio processing unit 306 decodes an audio signal from the control unit 301 to convert into an analog signal and output to the speaker 306b for reproduction.

The display processing unit 307 generates a video signal based on display information that is output from the control unit 301 and outputs the video signal to and display in the monitor 307a. The monitor 307a is, for example, a Liquid Crystal Display (LCD).

The input unit 308 is provided with, for example, an input key and outputs a control signal to the control unit 301 according to an input operation by a user. The camera module 309 is hardware to achieve functions as a camera and operates under a control of the control unit 301. The camera module 309 includes an optical mechanism such as a lens that receives light from an image pickup object such as the printed material 200, an image pickup element for receiving light that is incident through the lens, and a digitization circuit that digitizes an analog image signal that is output from the image pickup element. Moreover, the camera module 309 includes a processing circuit that executes processing to control Auto Focus (AF) and Auto Exposure (AE) based on a digital image signal that is output from the digitization circuit, compression coding processing for a digital image signal, and processing to execute various format conversions.

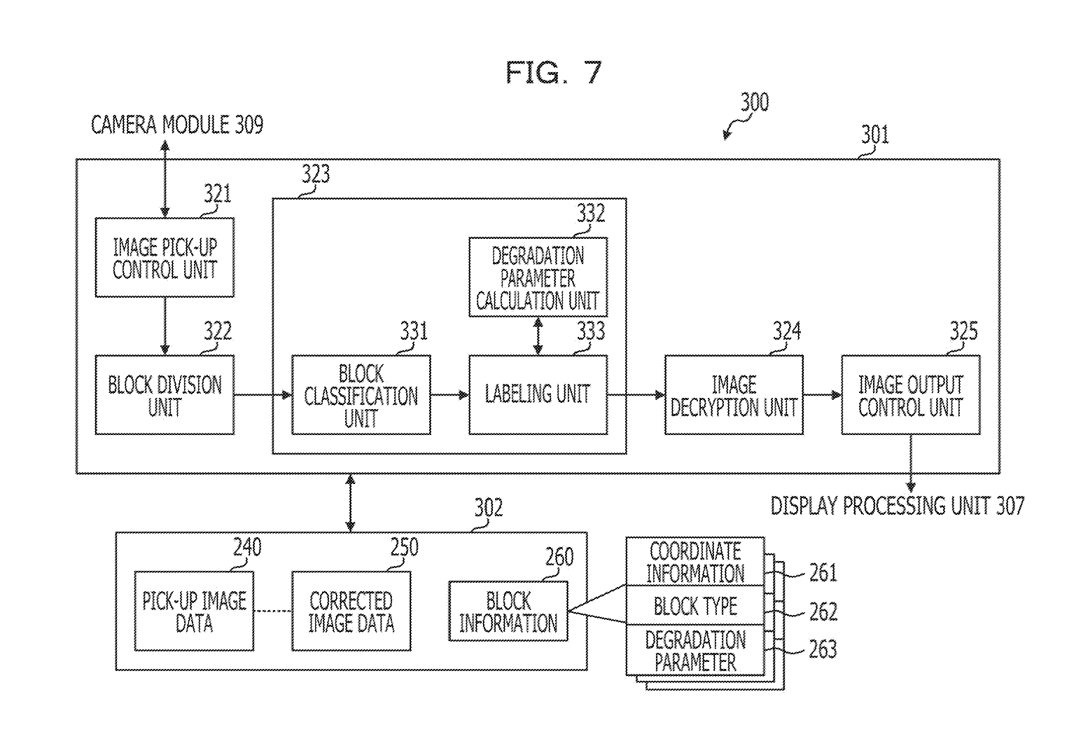

FIG. 7 is a block diagram illustrating functions provided with a mobile phone. As illustrated in FIG. 7, the mobile phone 300 includes an image pick-up control unit 321, a block division unit 322, an image quality correction unit 323, an image decryption unit 324, and an image output control unit 325. Furthermore, the image quality correction unit 323 includes a block classification unit 331, a degradation parameter calculation unit 332, and a labeling unit 333. The RAM 302 of the mobile phone 300 temporarily stores pick-up image data 240, corrected image data 250, and block information 260.

Each of the functions illustrated in FIG. 7 is achieved, for example, by executing a certain application program by the control unit 301. When the mobile phone 300 is set to an “image decryption mode” by an input operation to the input unit 308 by a user, the control unit 301 executes an image decryption application program, and each of the processing functions illustrated in FIG. 7 starts. At least a part of processing executed by processing functions illustrated in FIG. 7 may be achieved by a dedicated processing circuit.

The image pick-up control unit 321 makes the camera module 309 execute an image pick-up operation according to an operation input to the input unit 308 by the user, and obtains the pick-up image data 240 from the camera module 309 to store in the RAM 302. The image pick-up control unit 321 may make the camera module 309 pick up one still image. However, according to the embodiment, the image pick-up control unit 321 makes the camera module 309 pickup a moving image and extracts a frame with less blurring from the obtained plurality of frames.

The image pick-up control unit 321, for example, makes the camera module 309 pick up a moving image and calculates a contrast from data of sequentially obtained frames. The image pick-up control unit 321 stores data of a frame in the RAM 302 as the pick-up image data 240 when the contrast value of the frame is a certain value or more. Alternatively, the image pick-up control unit 321 makes the camera module 309 pick up a moving image in a certain period and may store data of a frame with substantially the highest contrast among the obtained plurality of frames in the RAM 302 as the image pickup data 240.

An image generated based on the pick-up image data 240 stored in the RAM 302 is referred to as a “pick-up image.” The “pick-up image” here corresponds to the pick-up image 230 illustrated in FIGS. 4 and 5.

The block division unit 322 divides the obtained pick-up image into blocks. According to the embodiment, the block division unit 322 detects the area identification markers 222 and the block identification markers 223 attached to the pick-up image as described in Operations S22 and S23 illustrated in FIG. 4, and divides the pick-up image into blocks based on the detected markers. According to the processing, the block division unit 322 recognizes blocks the positions of which are rearranged when the pick-up image is encrypted.

The RAM 302 stores block information 260 that includes information of each of the divided blocks. The block information 260 stores, for each block, information such as coordinate information 261, a block type 262, and a degradation parameter 263. The block information 260 indicates a range of coordinate of a block. The block type 262 identifies whether a block is a white block or a black block, which will be described later. The degradation parameter 263 indicates how much brightness of block is degraded. As will be described later, the degradation parameter 263 may be stored typically when the block type 262 indicates a white block.

The block division unit 322 registers coordinate information 261 for each of the divided blocks in the block information 260. The image quality correction unit 323 and the image decryption unit 324 refer to the coordinate information 261 when a luminance value of a pixel in a block corresponding, for example, to the coordinate information is read from the pick-up image data 240 and the corrected image data 250. Moreover, the image quality correction unit 323 and the image decryption unit 324 refer to the coordinate information 261, for example, when a luminance value of a pixel in the block corresponding to the coordinate information is written to the corrected image data 250.

The block division unit 322 erases the block identification markers 223 attached to the upper left of each block after dividing the pick-up image into blocks. The block division unit 322 performs an interpolation calculation, for example, based on luminance values of pixels located around the block identification marker 223 among pixels on the pick-up image and replaces the luminance value of each pixel of the block identification marker 223 with the luminance value obtained by the interpolation calculation. Replacing the luminance values as described above updates the pick-up image data 240.

Erasing the block identification marker 223 may be conducted, for example, for the corrected image data 250 that is input to the image decryption unit 324. In this case, the image correction unit 323 excludes luminance values of pixels included in the block identification marker 223 among pixels in each block from the processing.

The image correction unit 323 performs image quality correction processing that suppresses non-uniform luminance caused in the pick-up image due to the environmental conditions when the image is picked up. The image correction unit 323 generates corrected image data 250 the luminance values of which are corrected so that the non-uniform luminance is suppressed eventually. Hereinafter, an image based on the corrected image data 250 in which the luminance values are corrected by the image correction unit 323 is referred to as “corrected image.”

According to the embodiment, a storage area for the corrected image data 250 is provided in the RAM 302 at least prior to processing by the labeling unit 333 in the image correction unit 323. In the storage area of the corrected image data 250, a storage area corresponding to each pixel in the pick-up image is provided. The image correction unit 323 writes a corrected luminance value for each pixel in the storage area of the corrected image data 250. Writing a luminance value of each pixel in a storage area of the corrected image data 250 is called “labeling.”

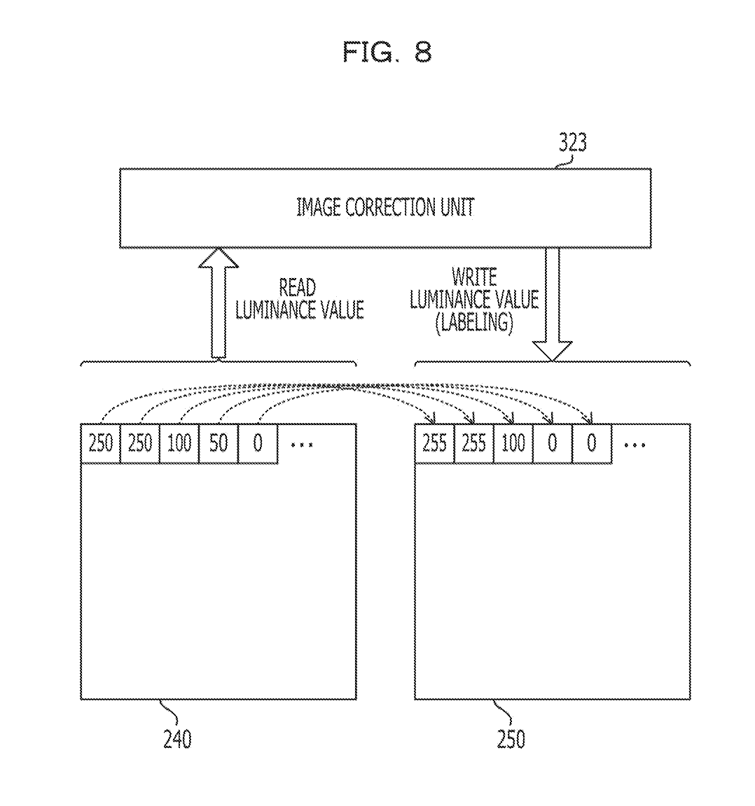

FIG. 8 illustrates a labeling process. The pick-up image data 240 stored in the RAM 302 includes luminance values of each of the pixels in the pick-up image 240. According to the embodiment, luminance values of each of the pixels in the pick-up image are from 0 to 255. Meanwhile, the corrected image data 250 generated in the RAM 302 includes a storage area corresponding to each pixel in the pick-up image. The image correction unit 323 writes one of values (labels) from 0 to 255 as a corrected luminance value in the storage area of each pixel in the corrected image data 250. The processing that writes a label as described above is called “labeling.” The image correction unit 323 completes the image quality correction processing by writing luminance values in the storage areas for all of the pixels in the corrected image data 250.

The image quality correction unit 323 refers to a luminance value in the pick-up image data 240 when calculating a value to be written to each pixel in the corrected image data 250. Storing the pick-up image data 240 and the corrected image data 250 separately in different areas allows writing a corrected luminance value in the corrected image data 250 while referring to luminance values before the correction included in the pick-up image data 240.

Now, return to FIG. 7. In the image correction unit 323, the block classification unit 331 determines whether each block obtained by division performed by the block division unit 322 is a white block or a black block. The block classification unit 331 registers the determination result in the block information 260 as a block type 262. The white block does not include any black pixel corresponding to a character area written in the original image. The black blocks are blocks other than the white blocks. The block classification unit 331 determines whether a block is a white block or a black block based on a variance of luminance values of each of the pixels in the block as will be described later.

The degradation parameter calculation unit 332 calculates a degradation parameter for each block in the pick-up image. The degradation parameter indicates how much brightness is reduced for each block when an image is picked up and is used for calculating a corrected luminance value. As will be described later, the degradation parameter of a black block is calculated based on luminance values of white blocks located around the black block. Through the above-described processing, luminance values of the pixels in the black block are corrected according to brightness of white blocks therearound. The degradation parameter calculation unit 332 registers the degradation parameter of the white block in the block information 260 as a degradation parameter 263.

The labeling unit 333 calculates a luminance value of each pixel in the corrected image based on the degradation parameter calculated by the degradation parameter calculation unit 332 and labels the calculated luminance value in a storage area of the corrected image data 250. The labeling unit 333 calculates a probability that each pixel in the black block is a white pixel that is not in a character area in the original image and a probability that each pixel in the black block is a black pixel that is in the character area in the original image, for example, based on the degradation parameter. The labeling unit 333 calculates a corrected luminance value for each pixel in the black block based on the result of probability calculations.

The image decryption unit 324 restores the original image by decrypting the encrypted image 210 included in the corrected image by rearranging blocks in the corrected image based on the decryption key as described in Operation S24 in FIG. 4.

The image output control unit 325 transmits data of the original image restored by the image decryption unit 324 to the display processing unit 307 and makes the monitor 307a display the restored original image. The image output control unit 325 may store the data of the restored original image in the flash memory 303 or the portable memory 304a. Alternatively, the image output control unit 325 may transmit the data of the restored original image to another device over a network through the wireless communication interface 305.

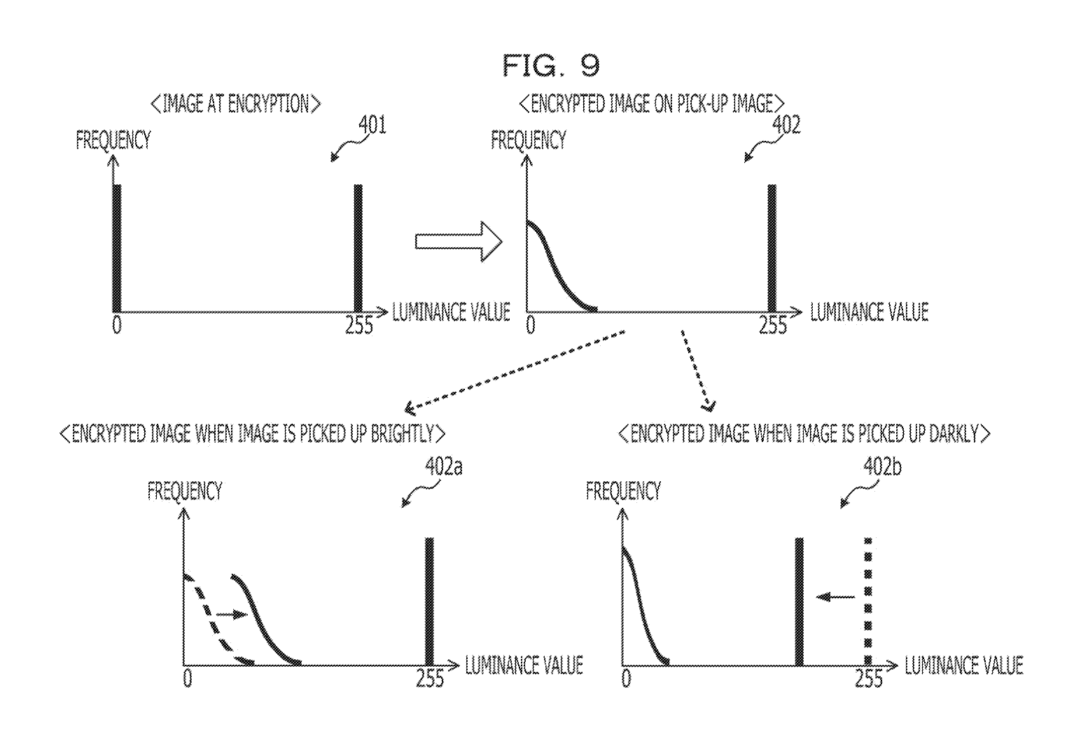

The image quality correction processing executed by the image quality correction unit 323 will be described. First, block classification processing by the block classification unit 331 is described. FIG. 9 illustrates statistical characteristics of encrypted images.

The graphs 401, 402, 402a, and 402b in FIG. 9 illustrate histograms of luminance values of the encrypted images 210 respectively. The graph 401 is a histogram of luminance values of the encrypted image 210 immediately after encryption processing conducted by the image encryption device 100. As illustrated in the graph 401, the encrypted image 210 generated by the image encryption device 100 is made up of black pixels with luminance values “0” included in the character area and white pixels with luminance values “255” included in the background area.

The graph 402 is a histogram of luminance value of the encrypted image 210 on an image picked-up by the mobile phone 300. It is assumed that substantially uniform lighting is illuminated over the entire encrypted image 210 when the image is picked up.

As illustrated in the graph 402, in the encrypted image 210 on the pick-up image, a variance of luminance values of white pixels does not substantially change, whereas a variance of luminance values of the black pixels tends to be increased. For example, when an image is picked up under a condition that the image is not still or out of focus, a blur is caused in the pick-up image. Even when a blur is caused white pixels remain to be white. Therefore, a variance of white pixels does not practically change from the state in the graph 401 and the variance is small.

Meanwhile, when a blur is caused, an area of black pixels, in other words, a character area of the encrypted image 210 bleeds. Particularly, luminance values of some black pixels may be substantially reduced at an edge between the character area and the background area. Moreover, when resolution of the image pickup element is low, the character area tends to bleed. Such bleeding makes the variance of luminance values of black pixels greater than the variance of luminance values of white pixels.

The encrypted image 210 that is picked up brightly (for example, over-exposure) and darkly (for example, under-exposure) are compared. As in the graph 402, it is assumed that substantially uniform light is illuminated over the entire encrypted image 210 when the image is picked up.

When the encrypted image 210 is picked up brightly, white pixels are in a state of a white smear. Thus, as illustrated in the graph 402a, luminance values of almost all of the white pixels are 255 and the variance of luminance values of white pixels is small in the same manner as the cases of the graphs 401 and 402. Meanwhile, although the luminance values of the black pixels are high in average compared with the case of the graph 402, the variance of luminance values of black pixels becomes greater than that of the white pixels in the same manner as in the graph 402.

When the encrypted image 210 is picked up darkly, the luminance values of white pixels are decreased as illustrated in the graph 402b. However, the luminance values of each of the white pixels are substantially uniformly decreased; thereby the variance of luminance values of the white pixels is less likely to be large. On the other hand, luminance values of black pixels are decreased in average compared with the case of the graph 402. However, a variance of luminance values of the black pixels becomes greater than a variance of luminance values of the white pixels.

Statistical characteristics of each block in the encrypted image 210 will be considered by referring to the above-described graphs 401, 402, 402a, and 402b . Statistical characteristics of luminance values of each of the pixels in a white block that does not include any black pixel in a character area may be considered substantially the same as the statistical characteristics of luminance values of white pixels illustrated in the graphs 402, 402a, and 402b.

There are two types of black blocks. One is a block that typically includes black pixels. The other is a block that has both black pixels and white pixels. Statistical characteristics of luminance values of each of the pixels in a black block that typically includes black pixels may be considered substantially the same as the statistical characteristics of luminance values of black pixels illustrated in the graphs 402, 402a, and 402b . Therefore, the variance of luminance values in the black block is greater than the variance of luminance values in the white block. Moreover, it is obvious that the variance of luminance values of a black block that includes both black pixels and white pixels is greater than the variance of luminance values of a white block that typically includes white pixels.

Characteristics that the variance of luminance values in a black block is greater than that of a white block appear even in a case that non-uniform luminance is caused in the encrypted image 210 due to environmental conditions when the image is picked up. This is because, the non-uniform luminance influences on both brightness of white pixels and black pixels, and if the non-uniform luminance is caused, both the variance of luminance values of white pixels and that of the black pixels are increased.

The block classification unit 331 determines whether a block obtained by division by the block division unit 322 is a white block or a black block based on a difference of variances of luminance values in each of the white block and black block. Hereinafter, examples of two types of block classification processing by the block classification unit 331 will be described.

In the first processing example of the block classification, the block classification unit 331 calculates a variance σb2 for each of the blocks obtained by division and compares the calculated σb2 with a certain threshold γ. The block classification unit 331 determines the focused block is a black block when the variance σb2 of luminance values in the focused block is the threshold γ or more. On the other hand, the block classification unit 331 determines the focused block is a white block when the variance σb2 of luminance values in the focused block is the threshold γ or less. Through the above-described processing, whether a focused block is a white block or a black block may be determined with high accuracy based on a difference of statistical characteristics of a white block and a black block.

In the second processing example of the block classification, the block classification unit 331 calculates a probability that a focused block is a white block by using the above-described difference of variances of luminance values. The block classification unit 331 determines whether the focused block is a white block or a black block according to the calculated probability. The block classification unit 331 calculates a probability that the focused block is a white block and a probability that the focused block is a black block by using a statistical model defining luminance values of each of the pixels included in the white block and the black block are distributed according to normal distribution. In the statistical model, setting a variance of the luminance values in a black block greater than a variance of the luminance values in the white block improves accuracy to determine whether a focused block is a white block or a black block.

A probability of occurrence (p|k) that the focused block b is a white block (k=w_block) or a black block (k=b_block) is defined, for example, by the following expression (1). The expression (1) indicates a probability (p|k) by the statistical model defining luminance values of each of the pixels included in the white block and the black block are distributed according to normal distribution.

$$p ( b \vert k ) = {\prod }_{i}^{b} \frac{1}{\sqrt{2 {πσ}_{1}^{2} ( k )}} exp \{ \frac{- {( {x}_{i} - {μ}_{b} )}^{2}}{{σ}_{1}^{2} ( k )} \} \qquad ( 1 )$$

In the expression (1), the xi is a luminance value of a pixel in the coordinate i among pixels included in the block b, while the μb is an average value of luminance values of each of the pixels included in the block b. Moreover, the σ12(k) is a variance of luminance values in a white block or a black block and is set beforehand. The variance σ12 (k=b_block) that is set when the probability for the black block (p|k=b_block) is calculated is greater than the σ12(p|k=w_block) that is set when the probability for the white block (p|k=w_block) is calculated.

The occurrence frequency p(k) of a white block or a black block is defined by the following expression (2), where an occurrence frequency of a white block and that of a black block are assumed to be ½ respectively.

p(k)=½ (2)

A probability that a focused block b is a white block or a black block may be obtained by the following expression (3) using Bayes' theorem based on the expressions (1) and (2). The Z in the expression (3) is defined by the expression (4).

$$\begin{matrix} p ( k \vert b ) = \frac{1}{Z} exp \{ ln ( p ( b \vert k ) p ( k ) ) \} & ( 3 ) \\ Z = exp \{ ln ( p ( b \vert k = w \_ block ) p ( k = w \_ block ) ) \} + exp \{ ln ( p ( b \vert k = b \_ block ) p ( k = b \_ block ) ) \} & ( 4 )\end{matrix}$$

The block classification unit 331 calculates a probability that a block is a white block p(k=w_block|b) for each block according to the expression (3). The block classification unit 331 sets a larger value for the variance σ12(k=b_block) than a value of σ12(k=w_block) as described above when performing a calculation by the expression (3).

The block classification unit 331 determines a focused block as a white block when the calculated probability p(k=w_{—block|b)} exceeds a certain threshold (for example, “0.7”). When the calculated probability p(k=w_block|b) is a threshold or less, the block classification unit 331 determines the focused block as a black block.

The block classification unit 331 may calculate a probability that each block is a black block p(k=b_block|b), for example, according to the expression (3). In this case, the block classification unit 331 determines the focused block as a white block when the calculated probability, p(k=b_block|b) is the threshold or less (for example, “0.3”). Meanwhile, the block classification unit 331 determines the focused block as a black block when the calculated probability, p(k=b_block|b) exceeds the threshold.

Through the above-described processing, whether the focused pixel is a white block or a black block may be determined with high accuracy based on statistical characteristics of a white block and a black block respectively. Alternatively, the block classification unit 331 may determine whether the focused block is a white block or a black block by calculating a probability that each block is a black block according to the expression (3) and comparing the calculated value with a threshold.

The block classification unit 331 records a determination result indicating whether the focused block is a white block or a black block in the RAM 302 as a block type 262. After completing classification of blocks, the labeling unit 333 calculates a luminance value of each pixel in a corrected image based on a degradation parameter calculated by the degradation parameter calculation unit 332 and labels the calculated luminance value in a storage area of the corrected image data 250. The degradation parameter indicates how much brightness is reduced when the image is picked-up for each block. The degradation parameter calculation unit 332 calculates a degradation parameter according to the procedures described below.

A degradation parameter μb′(k=w_block) of a white block is obtained by the following expression (5). The degradation parameter calculation unit 332 registers a degradation parameter μb′(k=w_block) calculated according to the expression (5) in a corresponding block entry in the block information 260 as a degradation parameter 263.

μb′(k=w_block)=μb (5)

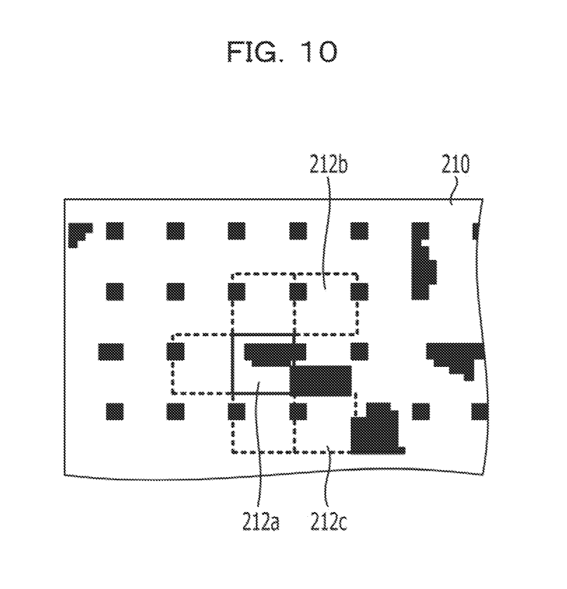

FIG. 10 is an example of blocks in a picked-up encrypted image. A method to calculate a degradation parameter for a black block will be described by referring to FIG. 10. In FIG. 10, the encrypted image 210 is indicated with block identification markers 223 remained so that a position of a block may be easily recognized.

In FIG. 10, the block surrounded by the solid line is a black block while the blocks surrounded by the dotted lines are white blocks. As described above, a white block typically includes white pixels. Thus, an average luminance value of a white block in the picked up encrypted image 210 (in other words, a degradation parameter of a white block) is an indicator that reflects how much brightness is reduced when the image is picked up more accurately compared with an average luminance value of a black block in which black pixels and white pixels may coexist.

Accordingly, the degradation parameter calculation unit 332 calculates a degradation parameter of a black block, μb′(k=b_block) by using luminance values of white blocks in the vicinity of the black block. For example, the degradation parameter calculation unit 332 assumes an average luminance value of one or more white blocks in the vicinity of the black block as the degradation parameter of the black block, μb′(k=b_block).

The degradation parameter of the black block, μb′(k=b_block) may be obtained by the following expression (6) using the calculated degradation parameter of a white block, μb′(k=w_block) (in other words, the degradation parameter 263 registered in the block information 260).

$${μ}_{b}^{′} ( k = b \_ block ) = {\sum }_{n}^{m} {μ}_{n} ( k = w \_ block ) \text{/} m \qquad ( 6 )$$

In the expression (6), n indicates a white block in the vicinity of the black block used when calculating the degradation parameter, while m indicates the number of white blocks used when calculating the degradation parameter.

The degradation parameter calculation unit 332 selects a black block one by one by referring, for example, to the block information 260, and selects white blocks in the vicinity of the selected black block. The degradation parameter calculation unit 332 reads a degradation parameter of the selected white block μb′(k=w_block) from the block information 260 and calculates a degradation parameter of the black block μb′(k=b_block) according to the expression (6).

It is desirable that the degradation parameter calculation unit 332 selects a white block that is close to the black block as much as possible when the degradation parameter of the black block μb′(k=b_block) is calculated. Moreover, in this case, selecting a plurality of white blocks is desirable. For example, the degradation parameter calculation unit 332 selects white blocks from eight blocks that are adjacent around the black block. At this time, the degradation parameter calculation unit 332 may preferentially select white blocks adjacent to the left, right, top and bottom of the black block. In the example of FIG. 10, a block adjacent to the right side of the black block 212a to be processed is a black block. Hence, the degradation parameter calculation unit 332 selects white blocks 212b and 212c that are adjacent to the upper right and the lower right of the black block 212a respectively instead of selecting a block adjacent to the right side of the black block 212a .

Moreover, substantially the minimum number of white blocks that are selected when calculating a degradation parameter of a black block μb′(k=b_block) may be defined. If substantially the minimum number of white blocks may not be selected from eight blocks adjacent to the black block, white blocks may further be selected from blocks around the blocks adjacent to the black block.

The labeling unit 333 calculates a luminance value of each pixel in the corrected image based on the degradation parameter calculated by the degradation parameter calculation unit 332. The labeling unit 333 labels the calculated luminance value in the storage area of the corrected image data 250. The labeling unit 333 sets a luminance value “255” for all of the pixels included in white blocks among pixels in the corrected image. On the other hand, the labeling unit 333 determines a corrected luminance value according to the above-described degradation parameter μb′(k=b_block) for pixels included in the black block among pixels in the corrected image. Hereinafter, two examples of labeling processing by the labeling unit 333 for pixels included in a black block will be described.

In the first example of labeling processing, the labeling unit 333 calculates likelihood that each pixel in a black block is white or black as probabilities respectively. For example, the labeling unit 333 calculates a probability that each pixel in the black block is a white pixel (in other words, pixels included in a background area in the encrypted image before printing) and a probability that each pixel in the black block is a black pixel (in other words, pixels included in a character area in the encrypted image before printing) respectively. The labeling unit 333 calculates the probabilities by using either a statistical model defining luminance values of white pixels in a black block follow normal distribution, or a statistical model defining luminance values of black pixels in a black block follow normal distribution.

The labeling unit 333 calculates a probability by one of the following two methods according to a degradation parameter of a black block μb′(k=b_block) calculated by the degradation parameter calculation unit 332.

Case 1: When a degradation parameter μb′(k=b_block) is “255” or more

When calculating a probability, the labeling unit 333 estimates an average luminance value for white pixels and black pixels in the black block respectively based on the average luminance value (in other words, the degradation parameter μb′(k=b_block)) in white blocks in the vicinity of the black block and sets the estimated average luminance value for the statistical model of normal distribution used for the probability calculation. However, if the degradation parameter μb′(k=b_block) is “255” or more, relatively strong light may be illuminated in the vicinity of the black block and a white smear may be caused. In this case, a luminance value of each pixel in the white blocks in the vicinity of the black block could be a saturated state. Thus, the labeling unit 333 may not accurately find how much brightness of the black block is increased compared with the original image from the degradation parameter μb′(k=b_block). Therefore, the labeling unit 333 may not estimate the average luminance value of the black pixels in the black block based on the degradation parameter μb′(k=b_block). However, the labeling unit 333 may estimate the average luminance value of the white pixels in the black block as “255.”

Accordingly, when the degradation parameter μb′(k=b_block) is 255 or more, the labeling unit 333 calculates a probability that a focused pixel is a white pixel p(k=w_pixel|xi) by using the statistical model defining the white pixels follow normal distribution. The probability p(k=w_pixel|xi) may be defined, for example, by the following expression (7). According to the expression (7), although an average luminance value and the variance for the white pixels are set when the probability is calculated, an average luminance value and the variance for the black pixels are not set (in other words, the statistical model defining the black pixels follow normal distribution is not used). Further, the labeling unit 333 calculates a probability that the focused pixel is a black pixel p(k=b_pixel|xi) by subtracting the probability p(k=w_pixel|xi) from “1” according to the expression (8).

$$\begin{matrix}p ( k = w \_ pixel \vert {x}_{i} ) = β \cdot exp ( - \frac{{α ( {x}_{i} - 255 )}^{2}}{{σ}_{2}^{2} ( k = w \_ pixel )} \} & ( 7 ) \\ p ( k = b \_ pixel \vert {x}_{i} ) = 1 - p ( k = w \_ pixel \vert {x}_{i} ) & ( 8 )\end{matrix}$$

In the expression (7), the α and β may be any empirically-derived value, for example, α=0.1 and β=1. Moreover, the variance of luminance values of white pixels in the black block σ22(k=w_pixel) may be substantially the same value as the variance that is set when calculating the probability for a white block (p|k=w_block) by using the expression (1).

The labeling unit 333 determines a corrected luminance value for the focused pixel based on the calculation results of the expressions (7) and (8), and labels the luminance value to a corresponding storage area in the corrected image data 250. The labeling unit 333 assumes the luminance value of the focused pixel as “0” when the probability that the focused pixel is a black pixel is higher than the probability that the focused pixel is a white pixel. Meanwhile, the labeling unit 333 assumes the luminance value of the focused pixel as “255” when the probability that the focused pixel is a white pixel is higher than the probability that the focused pixel is a black pixel.

Examples of probability calculations using the above-described expressions (7) and (8) will be described. In the example below, whether a pixel A1 and a pixel A2 that are adjacent each other in a black block are a white pixel or a black pixel are determined respectively. In the example, a variance of white pixels in the black block σ22(k=w_pixel) is set to “100.”

When a luminance value of the pixel A1 is assumed to be “250”, a probability that the pixel A1 is a white pixel is obtained by the following expression (9) and a probability that the pixel A1 is a black pixel is obtained by the expression (10).

$$\begin{matrix}\begin{matrix}p ( k = w \_ pixel ) = β \cdot exp \{ \frac{- {α ( {x}_{i} - 255 )}^{2}}{{σ}_{2}^{2} ( k = w \_ pixel )} \} \\ = exp \{ \frac{- 0.1 \times {( 250 - 255 )}^{2}}{100} \} \\ = 0.98\end{matrix} & ( 9 ) \\ p ( k = b \_ pixel ) = 1 - 0.98 = 0.02 & ( 10 )\end{matrix}$$

The labeling unit 333 determines the pixel A1 is a white pixel from the calculation results of the expressions (9) and (10), and labels the luminance value “255” to a corresponding storage area of the pixel A1 in the corrected image data 250.

Meanwhile, a luminance value of the pixel A2 that is adjacent to the pixel A1 is assumed to be “30”, the probability that the pixel A2 is a white pixel is calculated by the expression (11) and the probability that the pixel A2 is the black pixel is calculated by the expression (12).

$$\begin{matrix}\begin{matrix}p ( k = w \_ pixel ) = β \cdot exp \{ \frac{- {α ( {x}_{i} - 255 )}^{2}}{{σ}_{2}^{2} ( k = w \_ pixel )} \} \\ = exp \{ \frac{- 0.1 \times {( 30 - 255 )}^{2}}{100} \} \\ = 0\end{matrix} & ( 11 ) \\ p ( k = b \_ pixel ) = 1 - 0 = 1 & ( 12 )\end{matrix}$$

The labeling unit 333 determines the pixel A2 is a black pixel from the calculation results of the expressions (11) and (12) and labels the luminance value “0” to a corresponding storage area of the pixel A2 in the corrected image data 250.

Case (2) When the degradation parameter, μb′(k=b_block) is less than “255”

When the degradation parameter μb′(k=b_block) is less than “255”, brightness in the black block may be considered to be reduced when the image is picked up. In this case, the degradation parameter μb′(k=b_block) may be estimated to match with an average luminance value of white pixels in the black block. Meanwhile, an average luminance value of black pixels in the black block may be estimated to be “0.”

The labeling unit 333 calculates a probability that a focused pixel is a white pixel p(k=w_pixel|xi) and that a focused pixel is a black pixel p(k=b_pixel|xi) by setting the above-described estimated average luminance values of white pixels and black pixels as statistical model of normal distribution. A probability that a focused pixel is a white pixel or a black pixel is defined, for example, by the expression (13) by using Bayes' theorem. The Z in the expression (13) is defined by the expression (14).

$$\begin{matrix} p ( k \vert {x}_{i} ) = \frac{1}{Z} exp \{ ln \{ p ( {x}_{i} \vert k ) p ( k ) \} \} & ( 13 ) \\ Z = exp \{ ln \{ p ( {x}_{i} \vert k = b \_ pixel ) p ( k = b \_ pixel ) \} \} + exp \{ ln \{ p ( {x}_{i} \vert k = w \_ pixel ) p ( k = w \_ pixel ) \} \} & ( 14 )\end{matrix}$$

The probability p(xi|k) in the expressions (13) and (14) is obtained by the following expression (15). The expression (15) indicates a probability of occurrence that a focused pixel is a white pixel (k=w_block) or a black pixel (k=b_block) by a statistical model defining the luminance values of white pixels and the luminance values of black pixels distribute according to normal distribution.

$$p ( {x}_{i} \vert k ) = \frac{1}{\sqrt{2 {πσ}_{2}^{2} ( k )}} exp \{ \frac{- {β ( {x}_{i} - μ ( k ) )}^{2}}{{σ}_{2}^{2} ( k )} \} \qquad ( 15 )$$

The labeling unit 333 assumes the average luminance value of white pixels in the black block μ(k=w_pixel) as a value of the degradation parameter μb′(k=b_block) and assumes the average luminance value of black pixels in the black block μ(k=b_pixel) as 0 when performing calculation according to the expression (15). Accordingly, the probability p(k|xi) is calculated according to brightness of white blocks in the vicinity of the black block.

The labeling unit 333 sets a variance of white pixels in the black block, σ22(k=w_pixel) greater than a variance of black pixels in the black block, σ22(k=b_pixel) when performing calculation according to the expression (15). Accordingly, the probabilities, p(k=w_pixel|xi) and p(k=b_pixel|xi) are calculated based on a difference of statistical characteristics of white pixels and black pixels. As a result, calculation accuracy of each probability is improved.

The variance of white pixels, σ22(k=w_pixel) may be substantially the same value as the variance, σ12(k=w_block) that is set when calculating the probability for a white block using the expression (1). Likewise, the variance of black pixels σ22(k=b_pixel) may be substantially the same value as the variance, σ12(k=b_block) that is set when calculating the probability for a black block, (p|k=b_block) using the expression (1).

The p(k) in the expression (13) may be, for example, “½” as in the expression (2). The β in the expression (15) may be any empirically-derived value, for example, “1.”

The labeling unit 333 determines a corrected luminance value for a focused pixel from each calculation result of the probability, p(k=w_pixel|xi) and p(k=b_pixel|xi) by the expression (13) and labels the luminance value to a corresponding storage area in the corrected image data 250. The labeling unit 333 assumes, in the same manner as the case where the degradation parameter, μb′(k=b_block) is 255 or more, a luminance value of the focused pixel is 0 when a probability that the focused pixel is a black pixel is higher than a probability that the focused pixel is a white pixel. Meanwhile, the labeling unit 333 assumes a luminance value of the focused pixel is 255 when a probability that the focused pixel is a white pixel is higher than a probability that the focused pixel is a black pixel.

According to the labeling processing using the above expressions (13) to (15), the luminance correction value for each pixel in the black block is calculated according to the average luminance value in white blocks in the vicinity of the black block and also according to a difference of statistical characteristics of white pixels and black pixels. As a result, a luminance value of each pixel in the black block is corrected so as to suppress non-uniform luminance caused in the black block.

Examples of calculations using the above-described expressions (13) to (15) are indicated. In the example below, whether a pixel B in the black block is a white pixel or a black pixel is determined. In the example, a variance of white pixels in the black block σ22(k=w_pixel) is set to be 25, and a variance of black pixels in the black block σ22(k=b_pixel) is set to be 100 which is greater than the variance of white pixels σ22(k=w_pixel). Moreover, an average luminance value of white pixels in the black block μ(k=w_pixel) (in other words, the degradation parameter μb′(k=b_block))is assumed to be 200.

When the luminance value of the pixel B is 197, a probability that the pixel B is a white pixel is obtained by the expression (16).

$$\begin{matrix}p ( k = w \_ pixel ) = \frac{1}{Z} exp \{ ln ( \begin{matrix}\frac{1}{\sqrt{2 {πσ}_{2}^{2} ( k = w \_ pixel )}} \\ exp \{ \frac{- β ( {x}_{i} - {μ ( k = w \_ pixel )}^{2}}{{σ}_{2}^{2} ( k = w \_ pixel )} \}\end{matrix} \times \frac{1}{2} ) \} \\ = \frac{1}{Z} exp \{ \begin{matrix}- \frac{1}{2} ln ( 2 {πσ}_{2}^{2} ( k = w \_ pixel ) ) - \\ \frac{β ( {x}_{i} - {μ ( k = w \_ pixel )}^{2}}{{σ}_{2}^{2} ( k = w \_ pixel )} + ln ( \frac{1}{2} )\end{matrix} \} \\ = \frac{1}{Z} exp ( \begin{matrix}- \frac{1}{2} \times ln ( 2 \times 3.14 \times 25 ) - \\ \frac{1 \times {( 197 - 200 )}^{2}}{25} - 0.693\end{matrix} ) \\ = \frac{1}{Z} exp ( - 3.58 )\end{matrix} \qquad ( 16 )$$

Moreover, the probability that the pixel B is a black pixel is obtained by the expression (17).

$$\begin{matrix}p ( k = b \_ pixel ) = \frac{1}{Z} exp \{ ln ( \begin{matrix}\frac{1}{\sqrt{2 {πσ}_{2}^{2} ( k = b \_ pixel )}} \\ exp \{ \frac{- β ( {x}_{i} - {μ ( k = b \_ pixel )}^{2}}{{σ}_{2}^{2} ( k = b \_ pixel )} \}\end{matrix} \times \frac{1}{2} ) \} \\ = \frac{1}{Z} exp \{ \begin{matrix}- \frac{1}{2} ln ( 2 {πσ}_{2}^{2} ( k = b \_ pixel ) ) - \\ \frac{1 \times ( {x}_{i} - {μ ( k = b \_ pixel )}^{2}}{{σ}_{2}^{2} ( k = b \_ pixel )} + ln ( \frac{1}{2} )\end{matrix} \} \\ = \frac{1}{Z} exp ( \begin{matrix}- \frac{1}{2} \times ln ( 2 \times 3.14 \times 100 ) - \\ \frac{{( 197 - 0 )}^{2}}{100} - 0.693\end{matrix} ) \\ = \frac{1}{Z} exp ( - 392.00 )\end{matrix} \qquad ( 17 )$$

The Z in the expressions (16) and (17) is defined by the expression (18).

Z=exp(−3.58)+exp(−392.00)=0.0278 (18)

Accordingly, the probability that the pixel B is a white pixel is calculated as 1, while the probability that the pixel B is a black pixel is calculated as 0. The labeling unit 333 determines the pixel B is a white pixel from the calculation results of the expressions (16) to (18), and labels the luminance value 255 in a corresponding storage area of the pixel B in the corrected image data 250.

In the first example of the above-described labeling processing, the labeling unit 333 may determine a corrected luminance value for the focused pixel in the black block by calculating an expected value from the calculation results of the expressions (7) and (8), or from the expression (13). For example, the labeling unit 333 calculates a corrected luminance value xi′ according to the following expression (19). The expression (19) may be used regardless of a value of the degradation parameter μb′(k=b_block). The labeling unit 333 may not calculate the probability that the focused pixel is a black pixel p(k=b_pixel|xi) by using the expressions (8) or (13) when the corrected luminance value is calculated by using the expression (19).

xᵢ′=255×p(k=w_pixel|xᵢ)+0×p(k=b_pixel|xᵢ) (19)

When a luminance value is calculated by using the expression (19), a luminance value around an edge of a character area in the black block may be a value intermediate between 0 and 255. In this case, an effect is achieved that the edge of the character area is looked smoothly connected.

In the second example of labeling processing, when the degradation parameter μb′(k=b_block) is less than 255, the labeling unit 333 corrects the luminance value of each pixel in the black block based on the degradation parameter, μb′(k=b_block). For example, the labeling unit 333 calculates a corrected luminance value of each pixel xi′ in the black block according to the expression (20). Note that the labeling unit 333 limits the corrected luminance value to 255 if the luminance value calculated by the expression (20) exceeds 255.

xᵢ′=xᵢ×255/μ_{b}′(k=b_block) (20)

According to the expression (20), a luminance value of each pixel in the black block increases depending on how much brightness is degraded when the image is picked up so that the luminance value returns to the original value. In other words, the luminance value of each pixel is corrected so as to compliment the reduced amount of brightness when the image is picked up. The degree of brightness degradation is accurately calculated based on the average luminance value of pixels in white blocks in the vicinity of the black block. Thus, the luminance value of each pixel in the black block is corrected with high accuracy so that the luminance value becomes close to the original luminance value before the image is picked up. Accordingly, non-uniform luminance caused in the black block is suppressed. Furthermore, when a luminance value is calculated using the expression (20), an effect that the edge of the character area is looked smoothly connected is achieved as with the case when the expression (19) is used.

In the second example of labeling processing, the labeling unit 333 performs labeling by substantially the same procedures as the procedures of the above-described first example of labeling processing when the degradation parameter “μb′(k=b_block)” is 255 or more.

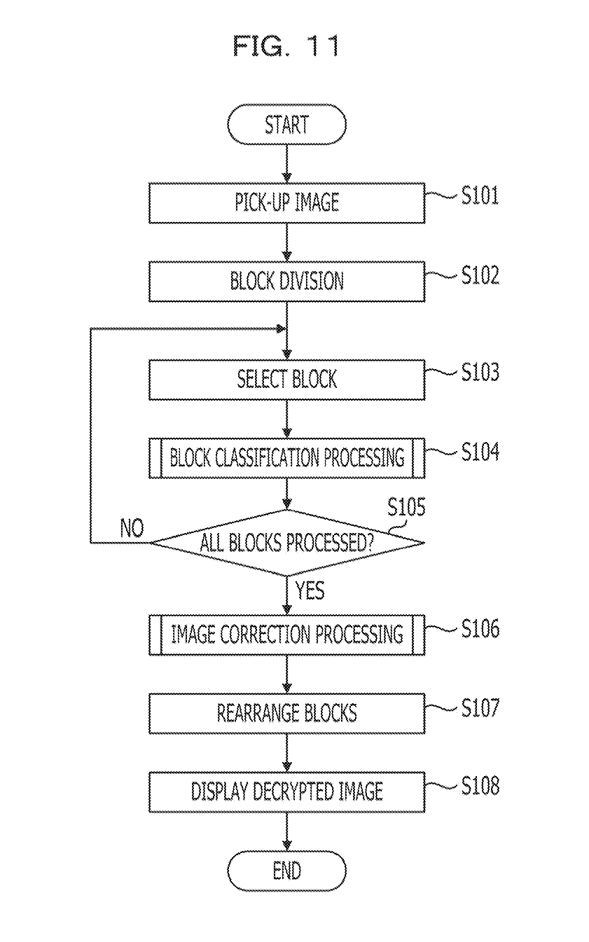

Processing by the above-described mobile phone 300 will be described by referring to a flow chart. FIG. 11 is a flow chart illustrating a whole processing procedure to display an encrypted image executed by the mobile phone.

The image pick-up control unit 321 makes the camera module 309 pick up an image and obtains the pick-up image data 240 from the camera module 309 to store in the RAM 302 (Operation S101).

The image pick-up control unit 321 makes, for example, the camera module 309 pick up a moving image and sequentially obtains the frame data. The image pick-up control unit 321 calculates a contrast whenever frame data is obtained and stores the frame data in the RAM 302 as the pick-up image data 240 if the contrast value is a certain value or more. Alternatively, the image pick-up control unit 321 makes the camera module 309 pick up a moving image for a certain period and may store frame data with substantially the highest contrast among obtained plurality of pieces of frame data in the RAM 302 as the pick-up image data 240.

The block division unit 322 divides an area of the encrypted image 210 (corresponds to the encryption target area 221) in the pick-up image into blocks. The block division processing is as described in the operations S22 and S23 in FIG. 4. The block division unit 322 registers coordinate information 261 for each of the divided blocks in the block information 260 (Operation S102).

The block division unit 322 divides the pick-up image into blocks, erases block identification markers 223 attached to an upper left of each block by an interpolation calculation, and updates the pick-up image data 240 to the data from which the block identification markers 223 are erased. Moreover, the block division unit 322 reads a luminance value of a pixel that is not included in the encrypted image 210 from the pick-up image data 240 and labels the luminance value to a corresponding storage area of the pixel in the corrected image data 250 in the RAM 302. Labeling a pixel that is not included in the encrypted image 210 may be executed any point of time as long as it is before executing Operation S108, which will be described later, and the labeling may be executed by the labeling unit 333 or the image decryption unit 324.

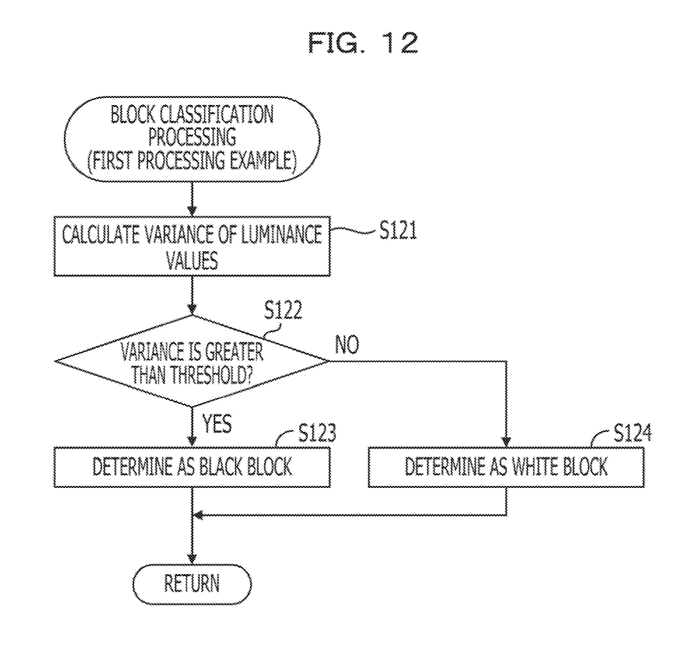

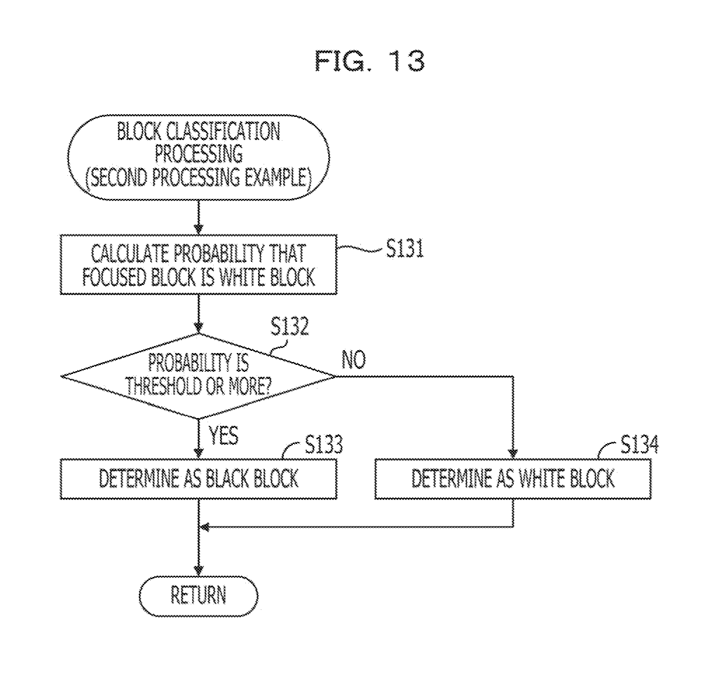

The block classification unit 331 refers to the block information 260 and selects one block that is not processed yet (Operation S103). The block classification unit 331 executes block classification processing to determine whether the selected block is a white block or a black block. The details of the block classification processing will be described by referring to FIGS. 12 and 13 later (Operation S104).

The block classification unit 331 determines whether block classification processing is executed for all of the blocks in the pick-up image. The block classification unit 331 executes the operation S103 if there is any unprocessed block. If all of the blocks are processed, the block classification unit 331 notifies to the labeling unit 333 accordingly. As a result, the processing of the operation S106 is executed (Operation S105).

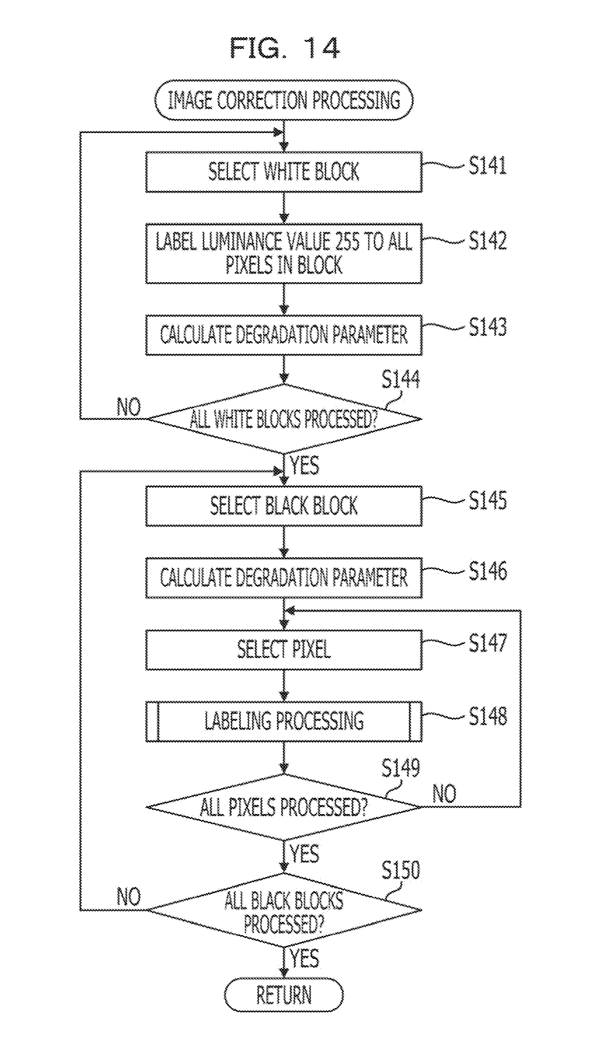

The labeling unit 333 and the degradation parameter calculation unit 332 execute image correction processing. The image correction processing suppresses non-uniform luminance in the encrypted image 210 caused due to environmental conditions when the image is picked up. Details of the image correction processing will be described later by referring to FIG. 14. When processing of the operation S106 is completed, luminance values are labeled to storage areas of all of the pixels (Operation S106).

The image decryption unit 324 refers to the coordinate information 261 in the block information 260 and reads luminance values of the encrypted image 210 for each block from the corrected image 250. The image decryption unit 324 rearranges the blocks in the encrypted image 210 according to a rule determined based on a decryption key as described in Operation S24 in FIG. 4. As a result, the encrypted image 210 is decrypted and the original image is restored. The image decryption unit 324 rewrites luminance values in the area of the encrypted image 210 in the corrected image data 250 with luminance values of the decrypted image (Operation S107).

The image output control unit 325 reads the corrected image data 250 in which the luminance values in the area of the encrypted image 210 are rewritten and supplies the corrected image data 250 to the display processing unit 307. Accordingly, an image in which the original image is restored is displayed on the monitor 307a (Operation S108).

In the above described processing in FIG. 11, blocks divided at Operation S102 is used as a unit to determine whether the block is a white block or a black block by the image correction unit 323, and also used as a unit to rearrange blocks by the image decryption unit 324. Note that a unit of block to determine whether the block is a white block or a black block by the image correction unit 323 (called a first block) and a unit of block to rearrange blocks by the image decryption unit 324 (called a second block) may be obtained by different division methods respectively.

For example, the number of pixels in the first block may be set larger than or smaller than the number of pixels in the second block. Furthermore, for example, the first block may be a plurality of mutually adjacent second blocks among the second blocks.

When there is no relation between a method to divide the pick-up image into first blocks and a method to divide the corrected image into second blocks, the image decryption unit 324 executes processing to divide the corrected image into the second blocks prior to rearranging the second blocks in Operation S107. In this case, after the block division unit 322 divides the pick-up image into the first blocks, data that corresponds to block identification markers 223 remains in the pick-up image data 240. The block identification markers 223 are detected from the pick-up image data 240 before the image decryption unit 324 divides the corrected image into second blocks and used for distortion correction and the second block division.

FIG. 12 is a flow chart illustrating a first example of block classification processing. Processing in FIG. 12 is executed by Operation S104 illustrated in FIG. 11.

The block classification unit 331 reads a luminance value of each pixel in the block selected at Operation S103 in FIG. 11 and calculates a variance of luminance values σb2 (Operation S121).

The block classification unit 331 compares the variance σb2 calculated at Operation S121 with a certain threshold γ. When the variance σb2 is greater than the certain threshold γ, the block classification unit 331 executes processing of Operation S123. When the variance σb2 is the certain threshold γ or less, the block classification unit 331 executes processing of Operation S124 (Operation S122).

The block classification unit 331 determines the block selected at Operation S103 as a black block, and registers a block type 262 indicating the block is a black block in a corresponding block entry in the block information 260. The processing returns to Operation S105 in FIG. 11 (Operation S123).

The block classification unit 331 determines the block selected at Operation S103 as a white block and registers a block type 262 indicating the block is a white block in a corresponding block entry in the block information 260. The processing returns to Operation S105 in FIG. 11 (Operation S124).

FIG. 13 is a flow chart illustrating a second example of block classification processing. Processing of FIG. 13 is executed at Operation S104 in FIG. 11.

The block classification unit 331 reads a luminance value of each pixel in the block selected at Operation S103 in FIG. 11 from the pick-up image data 240, and calculates a probability that the selected block is a white block, p(k=w_block|b) according to the expression (3). When calculating the expression (3), the block classification unit 331 sets a variance of a black block σ12(k=b_block) greater than a variance of a white block σ12(k=w_block). For the variance σ12(k=b_block) and the variance of a white block σ12(k=w_block), certain values are used (Operation S131).

The block classification unit 331 compares the probability p(k=w_block|b) calculated at Operation S131 with a certain threshold (for example, “0.7”). When the probability p(k=w_block|b) exceeds the threshold, the block classification unit 331 executes processing of the operation S133. When the probability p(k=w_block|b) is the threshold or less, the block classification unit 331 executes processing of the operation S134 (Operation S132).

The block classification unit 331 determines the block selected at Operation S103 as a white block and registers a block type 262 indicating the block is a white block in a corresponding block entry in the block information 260. The processing returns to Operation S105 in FIG. 11 (Operation S133).

The block classification unit 331 determines the block selected at Operation S103 as a black block and registers a block type 262 indicating the block is a black block in a corresponding block entry in the block information 260. The processing returns to Operation S105 in FIG. 11 (Operation S134).

FIG. 14 is a flow chart illustrating a processing procedure to correct image quality. Processing in FIG. 14 is executed at Operation S106 in FIG. 11.

The labeling unit 333 selects one white block which is not selected yet based on the block type 262 of the block information 260 (Operation S141).

The labeling unit 333 labels a luminance value 255 to a storage area of each pixel in the white block selected at Operation S141 among the storage areas for each of the pixels in the corrected image data 250 (Operation S142).

The degradation parameter calculation unit 332 reads a luminance value of each pixel in the white block selected at Operation S141 from the pick-up image data 240, and calculates a degradation parameter of the white block μb′(k=w_block) according to the expression (5). The degradation parameter calculation unit 332 registers the calculated degradation parameter μb′(k=w_block) in a corresponding block entry in the block information 260 as a degradation parameter 263 (Operation S143).

The labeling unit 333 determines whether Operations S141 to S143 are executed for all of the white blocks in the pick-up image. The labeling unit 333 executes processing of Operation S141 if there is any unprocessed white block. If all of the white blocks are already processed, the labeling unit 333 executes processing of Operation S145 (Operation S144).

The labeling unit 333 selects one black block which is not selected yet based on a block type 262 of the block information 260 (Operation S145).

The degradation parameter calculation unit 332 selects one or more white blocks in the vicinity of the black block selected at Operation S144 based on the coordinate information 261 and the block type 262 of the block information 260. The degradation parameter calculation unit 332 reads a degradation parameter of the selected one or more white blocks μb′(k=w_block) from the block information 260 and calculates a degradation parameter of the black block μb′(k=b_block) according to the expression (6) (Operation S146).

The degradation parameter calculation unit 332 may calculate a degradation parameter of the black block μb′(k=b_block) by reading luminance values of each of the pixels in the selected one or more white blocks from the pick-up image data 240 and calculating an average value of the read luminance values.

The labeling unit 333 selects one pixel in the black pixel selected at Operation S145 (Operation S147).

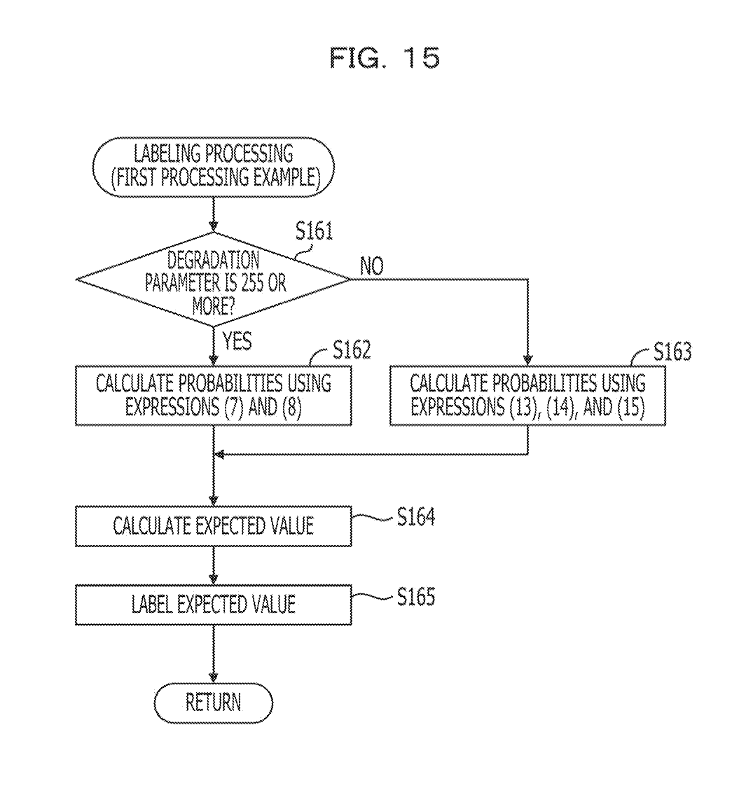

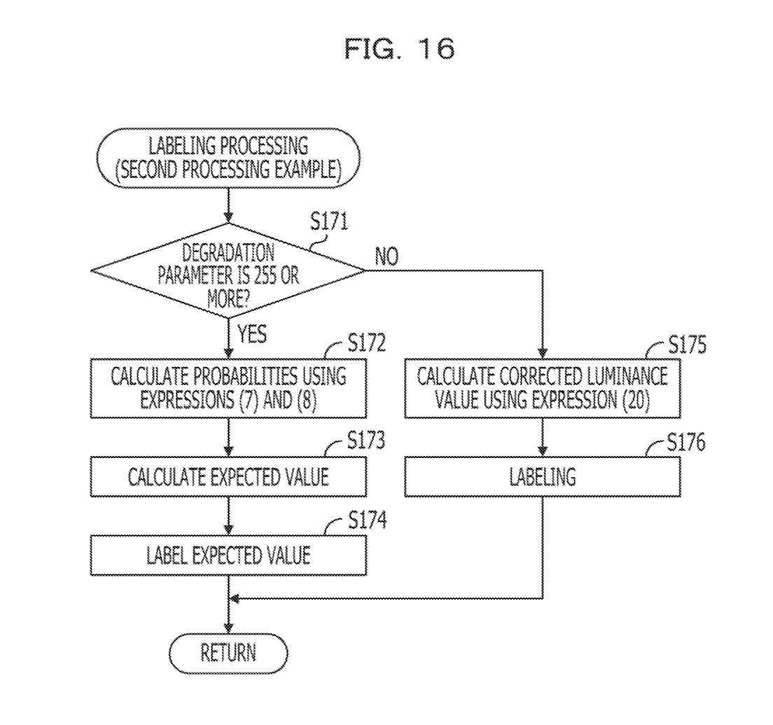

The labeling unit 333 calculates a corrected luminance value for a pixel selected at Operation S147, and labels the luminance value to a corresponding storage area of the pixel in the corrected image data 250 (Operation S148). The details of Operation S148 will be described later by referring to FIGS. 15 and 16.

The labeling unit 333 determines whether labeling processing is executed for all of the pixels in the black block selected at Operation S145. The labeling unit 333 executes processing of Operation S147 if there is any unprocessed pixel. The labeling unit 333 executes processing of Operation S150 if all of the pixels are already processed (Operation S149).

The labeling unit 333 determines whether Operations S145 to S149 are executed for all of the black blocks in the pick-up image. The labeling unit 333 executes processing of Operation S145 if there is any unprocessed black block. If all of the black blocks are processed, the labeling unit 333 notifies to the image decryption unit 324 accordingly. As a result, processing of the operation S107 in FIG. 11 is executed (Operation S150).

FIG. 15 is a flow chart illustrating a first processing example of a labeling. Processing of FIG. 15 corresponds to processing of Operation S148 in FIG. 14.

The labeling unit 333 determines whether the degradation parameter μb′(k=b_block) calculated at Operation S146 in FIG. 14 is 255 or more. The labeling unit 333 executes processing of Operation S162 when the degradation parameter μb′(k=b_block) is more than 255. The labeling unit 333 executes processing of Operation S163 when the degradation parameter μb′(k=b_block) is less than 255 (Operation S161).

The labeling unit 333 reads a luminance value of the pixel selected at Operation S147 in FIG. 14 from the pick-up image data 240. The labeling unit 333 calculates a probability that the selected pixel is a white pixel p(k=w_pixel|xi) and that of a black pixel p(k=b_pixel|xi) according to the expressions (7) and (8) respectively. In the calculation, the labeling unit 333 sets an average luminance value of black pixels in the black block selected at Operation S145 as 255 (Operation S162).

The labeling unit 333 reads a luminance value of a pixel selected at Operation S147 in FIG. 14 from the pick-up image data 240. The labeling unit 333 calculates a probability that the selected pixel is a white pixel p(k=w_pixel|xi) and a probability that the selected pixel is a black pixel p(k=b_pixel|xi) according to the expressions (13) to (15) based on the read luminance value (Operation S163).

In the calculation, the labeling unit 333 assumes the degradation parameter μb′(k=b_block) calculated at Operation S146 as an average luminance value of white pixels in the black block selected at Operation S145, and sets an average luminance of black pixels as 0. The labeling unit 333 sets a variance of black pixels in the black block σ22(k=b_pixel) greater than a variance of white pixels in the black block σ22(k=w_pixel).

The labeling unit 333 calculates an expected value according to the expression (19) based on a probability calculated at Operation S162 or Operation S163. The labeling unit 333 may practically calculate an expected value according to the expression (19) by typically calculating a probability that the selected pixel is a white pixel p(k=w_pixel|xi) in Operations S162 and S163 (Operation S164).

The labeling unit 333 labels the expected value calculated at Operation S164 to a corresponding storage area of the pixel in the corrected image data 250 as a luminance value of the pixel selected at Operation S147 in FIG. 14. The labeling unit 333 executes processing of Operation S149 in FIG. 14 (Operation S165).

The labeling unit 333 may determine a luminance value of a pixel as below based on the probability calculated at Operation S162 or Operation S163 instead of Operation S164 and Operation S165. The labeling unit 333 determines a luminance value of a pixel as 255 when a probability that the selected pixel is a white pixel p(k=w_pixel|xi) is substantially equal to, or greater than a probability that the selected pixel is a black pixel p(k=b_pixel|xi) and labels the luminance value to a corresponding storage area of the pixel in the corrected image. On the other hand, the labeling unit 333 determines the luminance value of the pixel as 0 when the probability that the selected pixel is a white pixel p(k=w_pixel|xi) is less than the probability that the selected pixel is a black pixel p(k=b_pixel|xi) and labels the luminance value to a corresponding storage area of the pixel in the corrected image.

FIG. 16 is a flow chart of a second processing example of a labeling. The processing of FIG. 16 corresponds to processing of Operation S148 in FIG. 14.

The labeling unit 333 determines whether the degradation parameter μb′(k=b_block) calculated at Operation S146 in FIG. 14 is 255 or more. The labeling unit 333 executes processing of Operation S172 if the degradation parameter μb′(k=b_block) is 255 or more. The labeling unit 333 executes processing of Operation S175 if the degradation parameter μb′(k=b_block) is less than 255 (Operation S171).

The labeling unit 333 calculates a probability that the pixel selected at Operation S147 in FIG. 14 is a white pixel p(k=w_pixel|xi) and that of a black pixel p(k=b_pixel|xi) according to the expressions (7) and (8) respectively in substantially the same manner as Operation S162 in FIG. 15 (Operation S172).

The labeling unit 333 calculates an expected value according to the expression (19) based on the probabilities calculated at Operation S172. The labeling unit 333 may practically calculate an expected value according to the expression (19) by typically calculating a probability that the selected pixel is a white pixel p(k=w_pixel|xi) in Operation S172 (Operation S173).

The labeling unit 333 labels the expected value calculated at Operation S173 to a corresponding storage area of the pixel in the corrected image data 250 as a luminance value of the pixel selected at Operation S147 in FIG. 14. The labeling unit 333 executes processing of Operation S149 in FIG. 14 (Operation S174).

The labeling unit 333 may determine a luminance value of a pixel as below based on the probability calculated at Operation S172 instead of Operations S173 and S174. The labeling unit 333 determines a luminance value of a pixel as 255 when a probability that the selected pixel is a white pixel p(k=w_pixel|xi) is substantially equal to or greater than a probability that the selected pixel is a black pixel p(k=b_pixel|xi) and labels the luminance value to a corresponding storage area of the pixel in the corrected image. On the other hand, the labeling unit 333 determines the luminance value of the pixel as 0 when the probability that the selected pixel is a white pixel p(k=w_pixel|xi) is less than the probability that the selected pixel is a black pixel p(k=b_pixel|xi) and labels the luminance value to a corresponding storage area of the pixel in the corrected image.

The labeling unit 333 reads a luminance value of the pixel selected at Operation S147 in FIG. 14 from the pick-up image data 240. The labeling unit 333 calculates a corrected luminance value according to the expression (20) based on the read luminance value and the degradation parameter μb′(k=b_block) calculated at Operation S146 (Operation S175).

The labeling unit 333 labels the luminance value calculated at Operation S175 to a corresponding storage area of the pixel in the corrected image data. The labeling unit 333 executes processing of Operation S149 in FIG. 14 (Operation S176).

According to the processing described by referring to FIGS. 11 to 16, the block classification unit 331 of the mobile phone 300 determines whether a block is a white block or a black block by utilizing statistical characteristics that a variance of luminance values in a black block is greater than a variance of luminance values in a white block. Accordingly, a white block and a black block may be determined with high accuracy.

Moreover, the labeling unit 333 of the mobile phone 300 corrects the luminance value of each pixel in the white block to “255.” Meanwhile, the labeling unit 333 corrects the luminance value of each pixel in the black block based on an average luminance value of pixels in white blocks in the vicinity of the black block.

A white block typically includes white pixels, thus an average luminance value of pixels in a white block accurately reflects a degree of degradation of brightness when the image is picked up if the average luminance value is smaller than substantially the maximum luminance value (in the above example, 255). Accordingly, the labeling unit 333 increases a luminance value of each pixel in the black block for the amount that is degraded when the image is picked up based on an average luminance value of pixels in white blocks in the vicinity of the black block. Through the correction of the luminance value, brightness of the black block is corrected so that non-uniform luminance is suppressed.

Through the above described block classification processing and image correction processing, a noise due to non-uniform luminance becomes less conspicuous in an image decrypted by the image decryption unit 324. Accordingly, the quality of the image after decryption is improved.

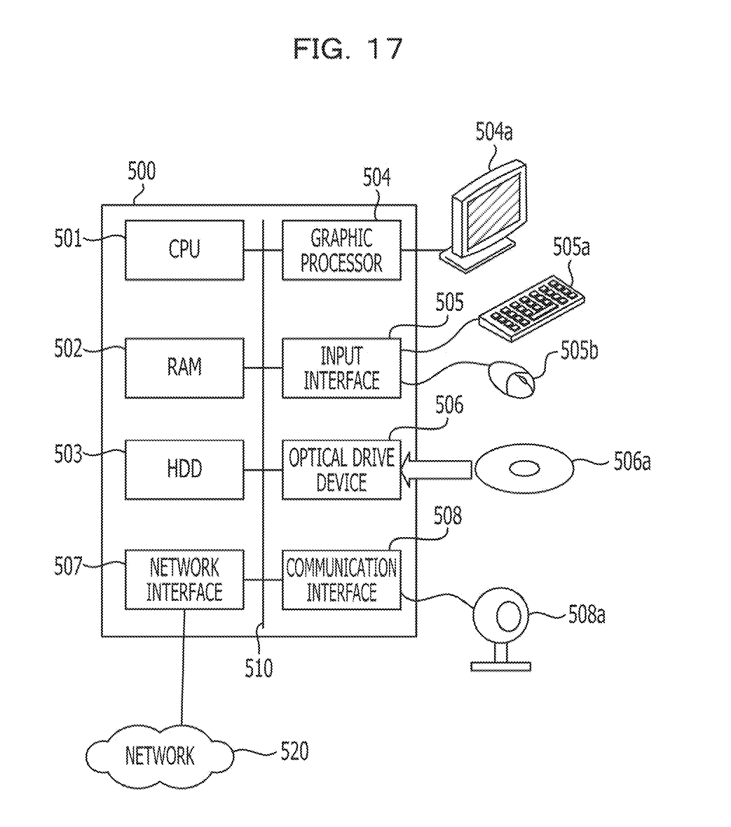

FIG. 17 is a hardware configuration example of a computer according to a third embodiment.

Processing functions of the mobile phone 300 described according to the second embodiment may be achieved, for example, by a computer 500 illustrated in FIG. 17. A CPU 501 controls the entire computer 500 illustrated in FIG. 17. A RAM 502 and a plurality of peripheral devices are connected to the CPU 501 through a bus 410.

The RAM 502 is used for a main storage of the computer 500. The RAM 502 temporarily stores at least a part of Operating System (OS) programs and application programs which are executed by the CPU 501. The RAM 502 stores various pieces of data that are required for processing by the CPU 101.

The peripheral devices that are connected to the bus 410 includes a hard disk drive (HDD) 503, a graphic processor 504, an input interface 505, an optical drive device 506, a network interface 507, and a communication interface 508.

The HDD 503 magnetically writes and reads data to and from an internal disk. The HDD 503 is used as a secondary storage device of the computer 500. The HDD 503 stores the OS programs, application programs, and various pieces of data. A semiconductor storage device such as a flash memory may be used as the secondary storage device.

The graphic processor 504 is connected to a monitor 504a. The graphic processor 504 makes the monitor 504a display an image on the screen according to an instruction from the CPU 501. The monitor 504a may be a display device using a Cathode Ray Tube (CRT) or a liquid crystal display device.

For example, a keyboard 505a and a mouse 505b are connected to the input interface 505. The input interface 505 transmits a signal received from the keyboard 505a and the mouse 505b to the CPU 501. The mouse 505b is one example of a pointing device and other types of pointing devices may be used. Other pointing devices include a touch panel, a tablet, a touchpad, and a track ball.

The optical drive device 506 reads data recorded in an optical disk 506a, for example, by using laser light. The optical disk 506a is a portable storage medium to which data is stored so as to be readable by reflection of light. The optical disk 506a may be a Digital Versatile Disc (DVD), a DVD-RAM, a Compact Disc Read Only Memory (CD-ROM), and a CD-Recordable (R)/ReWritable (RW).

The network interface 507 is connected to a network 520. The network interface 507 transmits and receives data to and from other computers or communication devices.

The communication interface 508 is connected to a camera 508a through a communication cable. The camera 508a picks up an image by an image pickup element and includes, for example, a mechanism and a circuit that are substantially the same as those of the camera module 309 illustrated in FIG. 6. The communication interface 508 transmits data of an image picked up by the camera 508a to the CPU 501. The communication interface 508 includes, for example, a Universal Serial Bus (USB) interface.

The above-described hardware configuration allows processing by the image pick-up control unit 321, the block division unit 322, the image quality correction unit 323, the image decryption unit 324, and the image output control unit 325 illustrated in FIG. 7. In this case, processing of each block may be achieved by execution of certain programs by the CPU 501. The image pick-up control unit 321 obtains data of an image picked up by the camera 508a. The image output control unit 325 makes the monitor 504 display an image in which an area of an encrypted image is decrypted.

The computer 500 may receive pick-up image data to be processed, for example, by the block division unit 322 from another device over the network 520. Alternatively, the computer 500 may read pick-up image data that is processed, for example, by the block division unit 322 from another portable storage medium such as the optical disk 506a. In either of the cases, the computer 500 may not include a processing function of the image pick-up control unit 321 in FIG. 7.

Moreover, the computer 500 may transmit, for example, image data in which an area of an encrypted image is decrypted to another device over the network 520. Alternatively, the computer 500 may write image data in which an area of an encrypted image is decrypted to a portable storage medium such as the optical disk 506a.

Programs to which processing contents of the above described functions of the computer 500 are written may be stored in a storage medium readable by the computer 500. The computer readable storage medium includes a magnetic storage device such as the HDD 503, the optical disk 506a, the magneto-optical storage medium, and a semiconductor memory. The magneto-optical storage medium includes a Magneto-Optical (MO) disk.

When programs are distributed, portable storage media such as DVDs and CD-ROMs to which the programs are stored are sold. Furthermore, the programs may be stored in a storage medium of a server computer and may be transferred to the computer 500 through the network.

The computer 500 that executes the programs stores the programs recorded in the portable storage medium or the programs transferred from a server computer in an own storage device such as the HDD 503. The computer 500 may read the programs directly from the portable storage medium and execute processing according to the programs. Moreover, the computer 500 may execute processing according to a program whenever the computer 500 receives the program from a server computer connected through the network.

Alternatively, a part of the above-described processing may be achieved by an electronic circuit such as a Digital Signal Processor (DSP), an Application Specific Integrated Circuit (ASIC), or a Programmable Logic Device (PLD).

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An image processing device comprising:
a block division unit configured to divide at least a part of an area of an input image into a plurality of blocks;
a block classification unit configured to classify each block in the input image into a white block and a black block based on a variance of luminance values in a white block that typically includes white pixels and a variance of luminance values in a black block that includes at least black pixels among white pixels and black pixels; and
a luminance correction unit configured to correct a luminance value of each pixel in a black block in the input image based on an average luminance value of pixels in one or more white blocks in the vicinity of the black block.

2. The device according to claim 1, wherein the block classification unit classifies a block into a black block when a variance of luminance values in the block in the input image is greater than a certain classification threshold, while the block classification unit classifies a block into a white block when a variance of luminance values in the block is the classification threshold or less.

3. The device according to claim 1, wherein the block classification unit calculates at least one of a probability that a block in the input image is a white block and a probability that the block in the input image is a black block by using a first variance in a block that is defined as a variance of luminance values in a white block and a second variance in a block that is defined as a variance of luminance values in a black block where the second variance is greater than the first variance and classifies the block into one of a white block and a black block based on the calculated probability.

4. The device according to claim 3, wherein the block classification unit calculates at least one of a probability that a block in the input image is a white block and a probability that the block in the input image is a black block by using a statistical model defining luminance values of pixels in a white block follow normal distribution and a statistical model defining luminance values of pixels in a black block follow normal distribution.

5. The device according to claim 1, wherein the luminance correction unit calculates at least one of a probability that each pixel in a black block in the input image is a white pixel and a probability that each pixel in the black block is a black pixel by using a first variance that is defined as a variance of luminance values of white pixels and a second variance that is defined as a variance of luminance values of black pixels where the second variance is greater than the first variance and by setting an average luminance value of pixels in one or more white blocks in the vicinity of the black block to be corrected as an average luminance value of white pixels in the black block, and corrects a luminance value of each pixel in the black block based on the calculated probability.

6. The device according to claim 5, wherein the luminance correction unit calculates at least one of a probability that each pixel in a black block in the input image is a white pixel and a probability that each pixel in the black block is a black pixel by using a statistical model defining luminance values of white pixels follow normal distribution and luminance values of black pixels follow normal distribution.

7. The device according to claim 5, wherein the luminance correction unit corrects a luminance value of each pixel in a black block in the input image to an expected value based on a probability that each pixel in the black block is a white pixel.

8. The device according to claim 1, wherein the luminance correction unit corrects a luminance value of each pixel in a black block in the input image so as to complement reduced brightness based on an average luminance value of pixels in one or more white blocks in the vicinity of the black block.

9. The device according to claim 1, wherein the luminance correction unit corrects luminance values of all pixels in a white block in the input image to a substantially maximum value of a gradation.

10. The device according to claim 1, wherein the block division unit divides an area of an encrypted image obtained by encrypting an original image in the input image into blocks.

11. The device according to claim 10, further comprising:
a decryption processing unit configured to decrypt the encrypted image by rearranging blocks, the luminance value of which are corrected by the luminance correction unit, based on a decryption key.

12. An image processing method comprising:
dividing at least a part of an area of an input image into a plurality of blocks;
classifying each block in the input image into a white block and a black block based on a variance of luminance values in a white block that typically includes white pixels and a variance of luminance values in a black block that includes at least black pixels among white pixels and black pixels; and
correcting a luminance value of each pixel in the black block in the input image based on an average luminance value of pixels in one or more white blocks in the vicinity of the black block.

13. The method according to claim 12, wherein the classifying classifies a block into a black block when a variance of luminance values in the block in the input image is greater than a certain classification threshold, while the classifying classifies the block into a white block when a variance of luminance values in the block is the certain classification threshold or less.

14. The method according to claim 12, wherein the classifying calculates at least one of a probability that a block in the input image is a white block and a probability that the block is a black block by using a first variance in a block that is defined as a variance of luminance values in a white block and a second variance in a block that is defined as a variance of luminance values in a black block where the second variance is greater than the first variance and classifies the block into one of a white block and a black block based on the calculated probability.

15. The method according to claim 12, wherein the classifying calculates at least one of a probability that a block in the input image is a white block and a probability that the block in the input image is a black block by using a statistical model defining luminance values of pixels in a white block follow normal distribution and a statistical model defining luminance values of pixels in a black block follow normal distribution.

16. A computer-readable non transitory storage medium storing an image processing program that causing a computer to execute a process comprising:
dividing at least a part of an area of an input image into a plurality of blocks;
classifying each block in the input image into a white block and a black block based on a variance of luminance values in a white block that typically includes white pixels and a variance of luminance values in a black block that includes at least black pixels among white pixels and black pixels; and
correcting a luminance value of each pixel in the black block in the input image based on an average luminance value of pixels in one or more white blocks in the vicinity of the black block.

17. The computer-readable non transitory storage medium according to claim 16, wherein the classifying classifies a block into a black block when a variance of luminance values in the block in the input image is greater than a certain classification threshold, while the classifying classifies the block into a white block when a variance of luminance values in the block is the certain classification threshold or less.

18. The computer-readable non transitory storage medium according to claim 16, wherein the classifying calculates at least one of a probability that a block in the input image is a white block and a probability that the block is a black block by using a first variance in a block that is defined as a variance of luminance values in a white block and a second variance in a block that is defined as a variance of luminance values in a black block where the second variance is greater than the first variance and classifies the block into one of a white block and a black block based on the calculated probability.

19. The computer-readable non transitory storage medium according to claim 16, wherein the classifying calculates at least one of a probability that a block in the input image is a white block and a probability that the block in the input image is a black block by using a statistical model defining luminance values of pixels in a white block follow normal distribution and a statistical model defining luminance values of pixels in a black block follow normal distribution.
